(19) United States
(12) Patent Application Publication
(10) Pub. No.: US 2003/0115164 A1
(43) Pub. Date: Jun. 19, 2003

(54) Neural network representation for system dynamics models, and its applications

(76) Inventors: Bingchiang Jeng, Kaohsiung (TW); Yao-Tsung Chen, Kaohsiung (TW)

Correspondence Address: INTELLECTUAL PROPERTY SOLUTIONS, INCORPORATED, 5717 COLFAX AVENUE, ALEXANDRIA, VA, 22311, US

(21) Appl. No.: 09/918,783

(22) Filed: Jul. 31, 2001

(51) Int. Cl. G06E 1/00; G06E 3/00; G06N 3/02; G06G 7/00; G06F 15/18

(52) U.S. Cl. 706/15

(57) ABSTRACT

The present invention relates to an artificial neural network (ANN) representation for system dynamics models (SDMs) and its applications in model construction and policy design. It first shows that, by a special design of the mapping scheme, a given flow diagram (FD) (i.e., traditional representation) can be transformed into a corresponding model in the representation of partial recurrent networks (PRNs) that will correctly behave like the one it mimics. The present invention shows the equivalence of the two types of representations, both structurally and mathematically. With the additional representation, an automatic learning method that can assist in the construction of SDMs is proposed, which starts from an initial skeleton of a PRN (mapping from an initial FD), identifies the cause-effect relationships within the SDM by neural learning, and then converts it back to the corresponding FD. The composite approach makes model construction simpler and more systematic. Similarly, by assigning an intended behavior pattern as a set of training examples for a given SDM, it can learn a new system structure with the PRN representation; the differences between the original and new structures lead to considerations of policy design. Besides, one can also allow the learning process to restart after some period of using a model so that it has a chance to evolve and adapt to temporal changes in the environment. This touches an area that has not yet been well solved; i.e., feedback to a system might change not only its behavior but also the internal system structure since, for example, a social system is usually organic.

### OTHER PUBLICATIONS

An, G. “The Effects of Adding Noise during Back-propagation Training on a Generalization Performance,” Neural Computation (8), 1996, pp. 643-647.

Aussem, A. “Dynamical Recurrent Neural Networks towards Prediction and Modeling of Dynamical Systems,” Neurocomputing (28), 1999, pp. 207-232.

Bailey, R., Bras, B. and Allen, J. K. “Using Response Surfaces to Improve the Search for Satisfactory Behavior in System Dynamics Models,” System Dynamics Review (16:2), 2000, pp. 75-90.

Burden, R. L., and Faires, J. D. Numerical Analysis, Prindle, Weber & Schmidt, Boston, 1985.

Burns, J. R., and Malone D. W. “Optimization Techniques Applied to the Forrester Model of the World,” IEEE Transactions on Systems, Man, and Cybernetics (4:2), 1974, pp. 164-171.

Clemson, B., Tang, Y., Pyne, J. and Unal R. “Efficient Methods for Sensitivity Analysis,” System Dynamics Review (11:1), 1995, pp. 31-49.

Coyle, R. G. “The Use of Optimisation Methods for Policy Design in a System Dynamics Model,” System Dynamics Reviews (1), 1985, pp. 81-92.

Dolado, J. J. “Qualitative Simulation and System Dynamics,” System Dynamics Reviews (8:1), 1992, pp. 55-81.

Elman, J. L. “Finding Structure in Time,” Cognitive Science (14), 1990, pp. 179-211.

Forrester, J. W. Industrial Dynamics, MIT Press, Cambridge, Mass., 1961.

Forrester, J. W. “Industrial Dynamics—After the First Decade,” Management Science (14:7), 1968, pp. 393-415.

Forrester, J. W. Principles of Systems, MIT Press, Cambridge, Mass., 1968.

Forrester, J. W. “Market Growth as Influenced by Capital Investment”, Industrial Management Review, 9(2), 1968, pp. 83-105.

Forrester, J. W. “System Dynamics, Systems Thinking, and Soft OR,” System Dynamics Review (10:2-3), 1994, pp. 245-256.

Holmstrom, L. and Koistinen, P. “Using Additive Noise in Back-propagation Training,” IEEE Transactions on Neural Networks (3), 1992, pp. 24-38.

Jordan, M. I. “Attractor Dynamics and Parallelism in a Connectionist Sequential Machine,” in Proceedings of the Eighth Annual Conference of the Cognitive Science Society, Hillsdale, N.J., 1986, pp. 531-546.

Kleijnen, J. P. C. “Sensitivity Analysis and Optimization of System Dynamics Models: Regression Analysis and Statistical Design of Experiments”, System Dynamics Review (11:4), 1995, pp. 275-288.

McCullagh, P. and Nelder, J. A. Generalized Linear Models 2nd ed., Chapman & Hall, London, 1989.

Mohapatra, P. K. J. and Sharma, S. K. “Synthetic Design of Policy Decisions in System Dynamics Models: A Modal Control Theoretical Approach,” System Dynamics Review (1), 1985, pp. 63-80.

Nie, J. “Nonlinear Time-Series Forecasting: A Fuzzy-neural Approach,” Neurocomputing (16), 1997, pp. 63-76.

Oja, E. and Wang, L. “Robust Fitting by Nonlinear Neural Units,” Neural Networks (9:3), 1996, pp. 435-444.

Ozveren, C. M. and Sterman, J. D. “Control Theory Heuristics for Improving the Behavior of Economic Models,” System Dynamics Review (5), 1989, pp. 130-147.

Randers, J. “Guidelines for Model Conceptualization,” in Elements of the system dynamics method Randers, J. (eds.), MIT Press, Cambridge, Mass., 1980.

Richardson, G. P. and Paugh A. L. III, Introduction to System Dynamics Modeling with DYNAMO, MIT Press, Cambridge, Mass., Reprinted by Productivity Press, Portland, Oreg., 1981.

Richmond, B., Vescuso, P. and Peterson, S., An Academic User's Guide to STELLA, High Performance System, Hanover, N.H., 1987.

Roberts, N. Andersen, D. F., Deal, R. M., Garet, M. S. and Shaffer, W. A. Introduction to Computer Simulation: the System Dynamics Modeling Approach, Addison-Wesley, Reading, Mass., 1983.

Sarle, W. S. Neural Network FAQ Part III, ftp://ftp.sas.com/pub/neural/FAQ3.html, 2000.

Scarselli, F. and Tsoi, A. C. “Universal Approximation Using Feed-forward Neural Networks: A Survey of Some Existing Methods, and Some New Results,” Neural Networks (11:1), 1998, pp. 15-37.

Senge, P. M. The Fifth Discipline: The Art and Practice of the Learning Organization, Doubleday, N.Y., 1990.

Starr, P. J. “Modeling Issues and Decisions in System Dynamics,” TIMS Studies in the Management Science (14), 1980, pp. 45-59.

Talavage, J. J. “Modal Analysis to Aid System Dynamics Simulation,” TIMS Studies in the Management Sciences (14), 1980, pp. 229-240.

Winston, P. H. Artificial Intelligence, Addison-Wesley, Reading, Mass., 1992.

Young, S. H. and Chen, C. P., “A Heuristic Mathematical Method for Improving the Behavior of Forrester's Market Growth Model,” in Proceeding of 16^{th} International Conference of the System Dynamics Society, 1998.

Zell, A. et al. SNNS User Manual Version 4.1, University of Stuttgart, Stuttgart, Germany, 1995.

Zhang, G. and Hu, M. Y. “Neural Network Forecasting of the British Pound/US Dollar Exchange Rate,” Omega (26:4), 1998, pp. 495-506.

### BACKGROUND OF THE INVENTION

1. The Definition of a System

According to Forrester [Forrester, J. W. Principles of Systems, MIT Press, Cambridge, Mass., 1968], a system is “a grouping of parts that operate together for a common purpose.” Two types of systems are identified: open loop and closed loop. An open-loop system responds to the incoming inputs, but its outputs are time-independent and do not affect the future behavior of the system. That is, the current behavior (or actions) has nothing to do with how the system will respond in the future. On the contrary, a closed-loop (or feedback) system is affected by its past behavior. In these systems, there exist at least one closed-loop structure that controls or affects the system's output based on its past behavior. System dynamics (SD) is the science of studying these kinds of system, and a “system dynamics model” (SDM) is an abstract representation of a real-world system.

2.Forrester Flow Diagram

In order to study the behavior of various types of systems, Forrester also proposed a set of notations to represent a SDM. Shown in FIG. 1 is a well-known Forrester flow diagram (FD) that describes a very simple inventory control system. In this diagram, the rectangles represent levels, which describe the conditions (or states) of the system at a particular time. Level variables accumulate the results of actions within a system. At each time interval, a new value for a level is calculated, which is determined by its previous value, the rates of flows into or out of the level, and the length of the time interval. A rate represented by a valve symbol in the diagram denotes a policy statement that describes an action on some levels in the system. Rate variables determine the rate of change (or slopes) of the level values; e.g., the order rate in FIG. 1. The value of a rate variable is dependent on values of other levels and constants, and this has nothing to do with its own past value, the time interval between computations, or other rate variables. Constants are variables whose values do not change over time during the simulation of a system, and they are denoted by horizontal lines in FIG. 1. The solid line with an arrow in FIG. 1 is a flow, which represents a quantity that is transferred from one level (or boundary) to another level (or boundary) in the system. (System boundaries are represented by clouds, which are used to define the borders of flows.) The dash lines with arrows in FIG. 1 are wires, which represent information flows from levels or constants to rates without depleting the sources. Not shown in FIG. 1 is another type of symbols (denoted by circles), called auxiliary variables, which lie in the information channels between levels and rates. An auxiliary variable is always a part of a rate equation, subdivided and separated because it expresses a concept that has an independent meaning.

In addition to the visible structure components, the more important one is its inside mathematical equations that simulate the operation of a system. A level equation in Forrester's format may take the following form:

L.K=L.J+DT×(RA.JK−RS.JK) (Eq. 1)

where

L is the level,

L.K is level L's new value,

L.J is level L's old value,

DT is the period between times J and K,

RA is the rate of an inbound flow into the level,

RA.JK is the rate value increases between times J and K,

RS is the rate of an outbound flow out of the level, and

RS.JK is the rate value between times J and K.

Rate equations denote how the flows within a system are controlled. Inputs to a rate equation are levels and constants. Its output controls a flow either into or out of a level. A rate equation in Forrester's format takes the following form:

R.KL=ƒ(all levels and constants)

Unlike level equations, whose functions are shown above, rate equations can be any arbitrary function with three restrictions: (1) a rate equation should not contain the interval DT; (2) there should be no rate variable on the right-hand side of a rate equation; and (3) the left-hand side of the equation contains the rate variable being defined.

In addition to level and rate equations, there are also constant equations, initial-value equations, and auxiliary equations. An auxiliary equation is merely an algebraic subdivision of a rate equation; its format and restrictions are the same as rate equations. Constant equations provide numerical values to constants. It is sometimes convenient to specify a constant in terms of another when the former depends on the latter. However, these equations are evaluated once only (at the beginning of the simulation) because by their very nature and definition, the values of constants do not vary during a simulation run. Initial-value equations provide the initial values to all levels at the beginning of the first simulation run. The right-hand side of an initial-value equation is defined in terms of numerical values, symbolically indicated constants, and the initial values of other levels.

3.Model Construction and Policy Design

Like other types of models, a construction method is required for a SDM. Previous examples of such methods are Starr, P. J. “Modeling Issues and Decisions in System Dynamics,” TIMS Studies in the Management Science (14), 1980, pp. 45-59; Randers, J. “Guidelines for Model Conceptualization,” in Elements of the system dynamics method Randers, J. (eds.), MIT Press, Cambridge, Mass., 1980; Roberts, N. et al. Introduction to Computer Simulation: the System Dynamics Modeling Approach, Addison-Wesley, Reading, Mass., 1983; and Forrester, J. W. “System Dynamics, Systems Thinking, and Soft OR,” System Dynamics Review (10:2-3), 1994, pp. 245-256.

Among these methods, there are at least three phases in common: preparation, model construction, and policy design. The first phase relates to the definition and conceptualization of the problem. The second phase (model construction) is a time-consuming process and is as much an art as a science. It initially assumes a set of cause-effect relationships in the system (based on experiences and observations) and then continuously refines the model until its behavior fits that of the real world. The third phase (policy design) is the real purpose of model construction, and is the phase in which one tries to change the behavior of the model by modifying some parts of its known structure.

The first phase is an abstraction process, which depends mainly on a constructor's observations, background knowledge, insight, and experiences to describe and conceptualize a problem—there is not much scope for automation. This is, however, not the case for the second phase, which traditionally also relies on a domain expert's deductive intelligence to manually identify the cause-effect relationships among variables. However, this is not very effective since it is a labor-intensive process that is performed by trial and error. The process also needs to check the validity of the model created. This process has not been automated not because it is not necessary but due to the lack of a proper tool. If a SDM could be transformed into the proper representation, existing methods (e.g., induction learning) from other disciplines could be applied, and the invention described here will show how to achieve this. The third phase is the most common one in which automatic algorithms are applied. In the past, much research work has focused on this phase in order to find a smart computer algorithm that might assist a human user in identifying high leverage policies.

According to Starr [Starr, P. J. “Modeling Issues and Decisions in System Dynamics,” TIMS Studies in the Management Science (14), 1980, pp. 45-59], a policy is the activity of: (1) assigning alternative values for parameters (a parameter-level policy), (2) changing linkages among system elements (a structure-level policy), and/or (3) inserting alternate elements into a model (a boundary-level policy). A policy may fall into one or more of these categories. The approaches to policy design can be formal or informal. Informal approaches depend on domain experts' own capabilities and training; they may result in acceptable policies in some specific models, but it is difficult to generalize such approaches. Formal approaches, on the other hand, use a systematic method to search for a policy, which can be applied to a general model.

Many formal approaches have been published. At the parameter level, they include: (1) sensitivity analysis, to find a better value for one parameter [e.g., Richardson, G. P. and Paugh A. L. III Introduction to System Dynamics Modeling with DYNAMO, MIT Press, Cambridge, Mass., Reprinted by Productivity Press, Portland, Oreg., 1981; Richmond, B., Vescuso, P. and Peterson, S. An Academic User's Guide to STELLA, High Performance System, Hanover, N.H., 1987]; (2) experimental design technique, to find better values for multiple parameters [e.g., Clemson, B., Tang, Y., Pyne, J. and Unal R. “Efficient Methods for Sensitivity Analysis,” System Dynamics Review (11:1), 1995, pp. 31-49; Kleijnen, J. P. C. “Sensitivity Analysis and Optimization of System Dynamics Models: Regression Analysis and Statistical Design of Experiments”, System Dynamics Review (11:4), 1995, pp. 275-288]; and (3) optimal algorithms, to find a total combination for all the parameters [e.g., Burns, J. R., and Malone D. W. “Optimization Techniques Applied to the Forrester Model of the World,” IEEE Transactions on Systems, Man, and Cybernetics (4:2), 1974, pp. 164-171; Bailey, R., Bras, B. and Allen, J. K. “Using Response Surfaces to Improve the Search for Satisfactory Behavior in System Dynamics Models,” System Dynamics Review (16:2), 2000, pp. 75-90].

The above approaches are limited only in the parameter level to searching for solutions to improve a system's performance. Since “structure influences behavior” [e.g., Senge, P. M. The Fifth Discipline: The Art and Practice of the Learning Organization, Doubleday, N.Y., 1990], the performance of these approaches is limited. Policy design approaches that fall in the structure level include: (1) optimal algorithms, that determine policies for a single decision point [e.g., Coyle, R. G. “The Use of Optimisation Methods for Policy Design in a System Dynamics Model,” System Dynamics Reviews (1), 1985, pp. 81-92]; and (2) modal control theory, that determines policies by solving the differential equations obtained from a SDM [e.g., Talavage, J. J. “Modal Analysis to Aid System Dynamics Simulation,” TIMS Studies in the Management Sciences (14), 1980, pp. 229-240; Mohapatra, P. K. J. and Sharma, S. K. “Synthetic Design of Policy Decisions in System Dynamics Models: A Modal Control Theoretical Approach,” System Dynamics Review (1), 1985, pp. 63-80]. A summary classification of the approaches is shown in Table 1.

TABLE 1
Classification of policy design methods.

| | | Single Point | Multiple Points | Overall |
|---|---|---|---|---|
| Parameter Level | | [Richardson and Pugh, 1981] | [Clemson et al., 1995] | [Burns and Malone, 1974] |
| | | [Richmond et al., 1987] | [Kleijnen, 1995] | [Bailey et al., 2000] |
| Struc- | Wires | [Coyle, 1985] | | |
| ture | | [Talavage, 1980] | | |
| Level | | [Mohapatra and Sharma, 1985] | | |
| | Flows | | | |

Boundary Level

Previous methods have been limited to determining better alternatives for either a set of parameter values or a single decision function on a dominated loop, and so it can be seen in Table 1 that a vacancy exists at the rightmost cell in the second row. The invention described here will fill this void and show how to create a policy from an overall perspective that covers both parameter and structure levels.

4.Artificial Neural Networks

Artificial neural networks (ANNs) are a type of knowledge representation that has been studied in the field of artificial intelligence for many years. Like SD, it also stores knowledge in the system structure rather than in the units themselves. Its particular application is mimicking the structure of a biological brain, which consists of a large set of brain cells interconnected to form a complicated system with electrical messages propagating between its cells in response to stimuli from the outside world. An ANN can be readily simulated by program functions.

To use an ANN for problem solving, one usually needs first to decide the structure of the network. Different types of problems need different structures; typical issues to be considered are: the network types, the number of hidden layers, and the number of units for each layer. A typical structure is shown in FIG. 2, where numeric data all propagate in one direction to the output layer and there is no feedback. This type of network (called a feed-forward network) is suitable for problems where outputs are dependent only on inputs. Once the initial network is created, it enters a learning phase in which one has to determine a training data set, learning rate parameter, and the convergence of the network. After the training phase, it is necessary to evaluate whether the created network has solved the problem.

The present invention uses a special type of ANNs called partial recurrent networks (PRNs). There are variants of PRNs; the most common ones can be found in Jordan, M. I. “Attractor Dynamics and Parallelism in a Connectionist Sequential Machine,” in Proceedings of the Eighth Annual Conference of the Cognitive Science Society, Hillsdale, N.J., 1986, pp. 531-546 and Elman, J. L. “Finding Structure in Time,” Cognitive Science (14), 1990, pp. 179-211. According to Elman's definition, a PRN is a kind of ANN with recurrent links that are used to associate a static pattern (a “Plan”) with a serially ordered output pattern (a sequence of “Actions”). FIG. 4(c) is an example of such a PRN, in which there is a new type of unit, called a “state” unit, in the input layer. Jordan's network connects the output units to these state units directly (i.e., recurrent inputs). Elman's network renames the state units as context units and allows the connections of recurrent links to each layer within a network.

### SUMMARY OF THE INVENTION

The present invention relates to an artificial neural network (ANN) representation for system dynamics models (SDMs) and its applications in model construction and policy design. It points out and utilizes an important similarity between SDMs and ANNs; both of which store knowledge mainly in the structure of a model—not in the units but in the links between units. By a special design of the mapping scheme, the present invention shows that a given flow diagram (FD) (i.e., the traditional representation) can be transformed into a corresponding model in the representation of PRNs that will correctly behave like the one it mimics. It also shows the equivalence of the two types of representations, both structurally and mathematically.

With the additional representation for a SDM, the present invention then shows how to apply this mechanism; that is, using the automatic learning capability of a PRN to assist in the construction of a SDM, policy design as well as model evolution. Given a set of prepared examples, a PRN can learn to fit the data pattern by adjusting its internal structure. This will help the model constructor to identify the cause-effect relationships inside a system. Similarly, by assigning an intended behavior pattern as a set of training examples for a given SDM, it can learn a new system structure with the PRN representation; the differences between the original and new structures lead to considerations of policy design. Besides, one can also allow the learning process to restart after some period of using the model so that it has a chance to evolve and adapt to temporal changes in the environment. This touches an area that has not yet been well solved; i.e., feedback to a system might change not only its behavior but also the internal system structure since, for example, a social system is usually organic.

### BRIEF DESCRIPTION OF THE DRAWINGS

FIG. 1 shows an inventory model.

FIG. 2 shows a typical ANN.

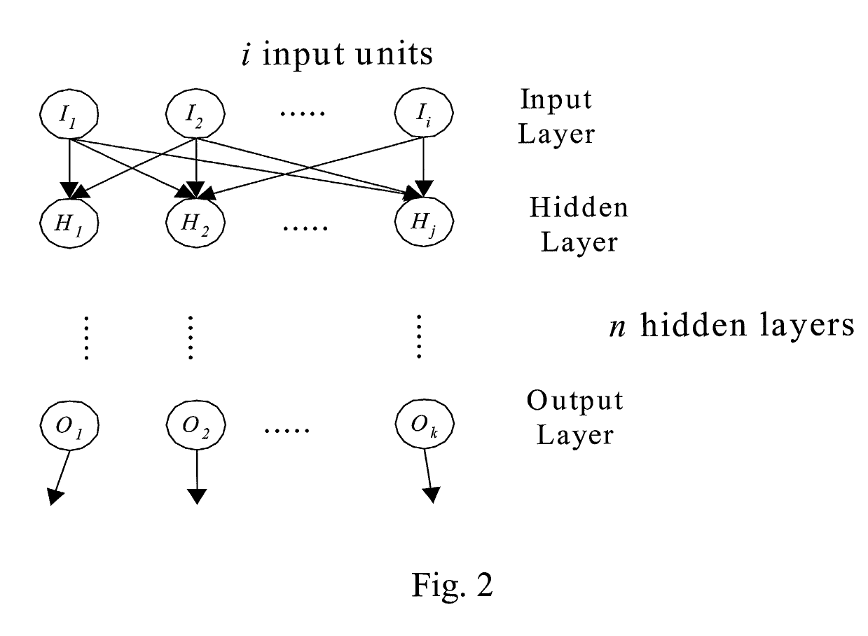

FIG. 3 shows an algorithm of transforming a FD into a PRN (FD2PRN).

FIG. 4 shows the PRN representation of the SDM in FIG. 1.

FIG. 5 shows a FD and its corresponding PRN in which level L1 is affected by itself via two feedback paths.

FIG. 6 shows a typical unit of a neural network that mimics a biological cell.

FIG. 7 shows the mapping between a level equation and a part of the PRN.

FIG. 8 shows the mapping between an initialization equation and a part of the PRN.

FIG. 9 shows the mapping between a constant equation and a part of the PRN.

FIG. 10 shows a Forrester's model construction procedure.

FIG. 11 shows a semi-automatic construction procedure for SDMs.

FIG. 12 shows weights with absolute meaning.

FIG. 13 shows weights with relative meaning.

FIG. 14 shows four system dynamic models in FD representations: (a) first-order inventory model, (b) second-order inventory model, (c) salesmen model, and (d) business model.

FIG. 15 represents the four models of FIG. 14 in PRN format.

FIG. 16 shows a simplified market growth model.

FIG. 17 shows the performance of policies found for the market growth model.

FIG. 18 shows simplified customer, producer, and employment models.

### DETAILED DESCRIPTION OF THE INVENTION

This invention will show a mapping scheme that can transform the FD representation of a SDM into the PRN and vice versa, so that a problem solver can take advantage of the different characteristics of each representation in a particular application. In particular, it will show how to use the learning capability of PRNs to assist in the construction of SDMs, design high-leverage policies as well as monitor the evolution of models. It is now described in detail how the mapping scheme is established.

1. Structure Mapping

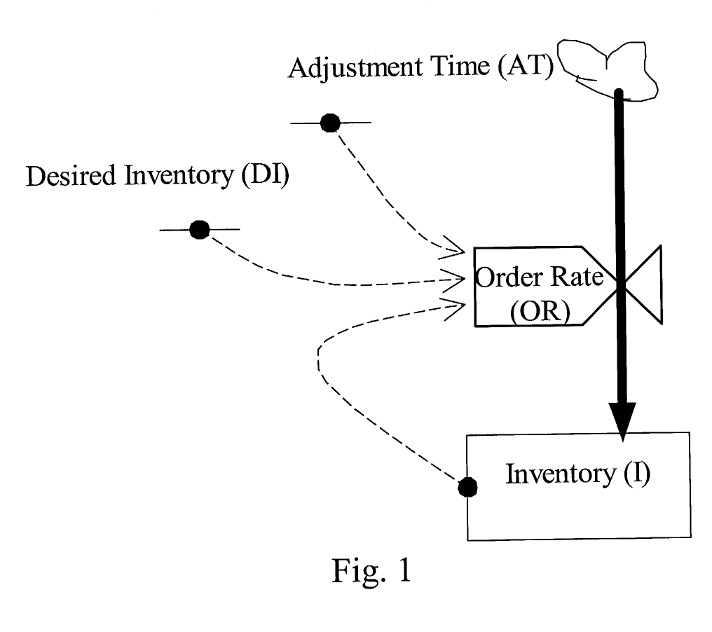

Let us consider again the simple FD for an inventory control system shown in FIG. 1. Within this model, there is a decision point (Order Rate) that controls the flow into a level (Inventory). Note that a flow is always coupled with a rate. There must be exactly one rate on each flow, and no flow can be present without a corresponding rate. The model is classified as a first-order system since it has only one level variable, which maintains the system's memory. It describes an inventory control system in which there is no delay between the ordering and receiving of goods. The function of the order rate (OR) is to bring the actual inventory (I) to a desired inventory level (DI). If the actual inventory level is below the target, the order rate increases; otherwise, it decreases. The difference between DI and I should be adjusted within time interval AT, in which DI and AT are all constants and propagated to OR through wires.

The numeric equations/constraints related to the system in FIG. 1 are the following:

I(t)=I(t−DT)+(OR)×DT

OR=(1/AT)×(DI−I)

DI=6000

AT=5

In order to explain how to find a mapping for this model in PRNs, let us take a close look at each part of a FD. The most important and obvious components in a FD are “levels”, whose function is to exchange information with the outside world and keep a memory of the state of a system; that is, accept an initial value before simulation and accumulate the result after each time step. From the previous description for PRNs, one can see that there is no single component in a neural network that matches such a level component. Instead, the functions of a level are distributed between three different components in a PRN: an input unit, an output unit, and a state unit. The input and output units together serve as the interface of the network, where data may be fed in or retrieved, respectively. The state unit takes over the other function of a level, and keeps the previous value of an output unit in a network (i.e., the state of the network).

The second important components in a FD are “rates”, whose function is to control the amount of flow into or out of a level at each time step. Discovering the existence of the rate on a “flow” is not always easy. It usually relies on the skill and insight of a model constructor. This is also true for a hidden unit in an ANN, which hides inside and defines a function to relate input stimuli to output units. In addition, the number of hidden units required in a network is also dependent on the experience of a network constructor. Therefore, it is natural to map a rate component to a hidden unit and its associated flow as a link between a hidden unit and an output unit in a PRN. (“Auxiliary” components will not be discussed here—they are optional in a FD and can always be a subdivided part of a rate equation, which can be treated like a “rate in front of another rate” in the mapping.)

The third type of component in a FD is a “wire”, which is simply a connection between a rate and some information source like a level or a “constant”. The mapping is therefore easy, being a link between a state unit and a hidden unit in a corresponding PRN. As to the mapping of a constant, depending on its usage in a FD it can be either treated like a (constant) level or viewed as a coefficient in a rate function (this will be explained in the next section).

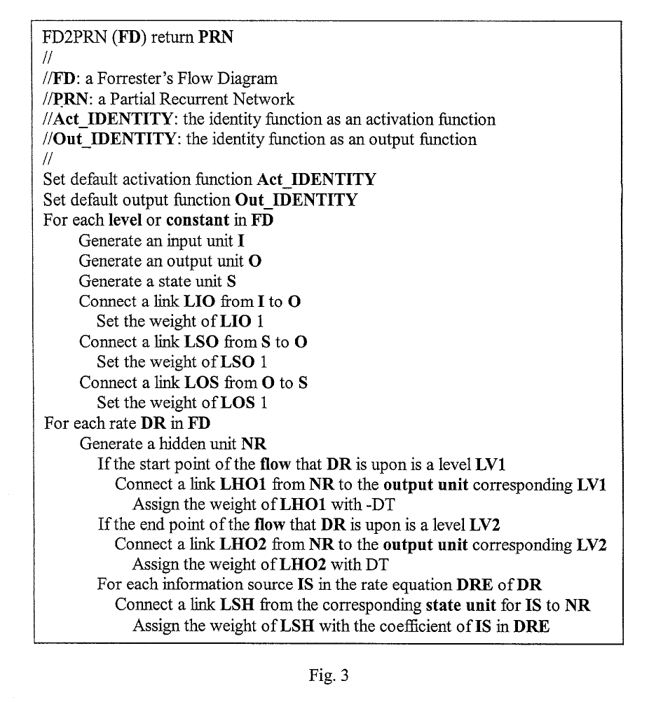

The algorithm (FD2PRN) that physically implements the above informal mapping is shown in FIG. 3. The input to the algorithm is a FD while its output is a PRN. Without lost of generality, it assumes that a FD is only composed of levels, rates, flows, wires, constants, and system boundaries. (System boundaries have no physical meaning in a PRN.) Other modeling components not given here are all derivable from these basic components. So the PRN generated by the algorithm will be expressive enough to cover any kind of FDs.

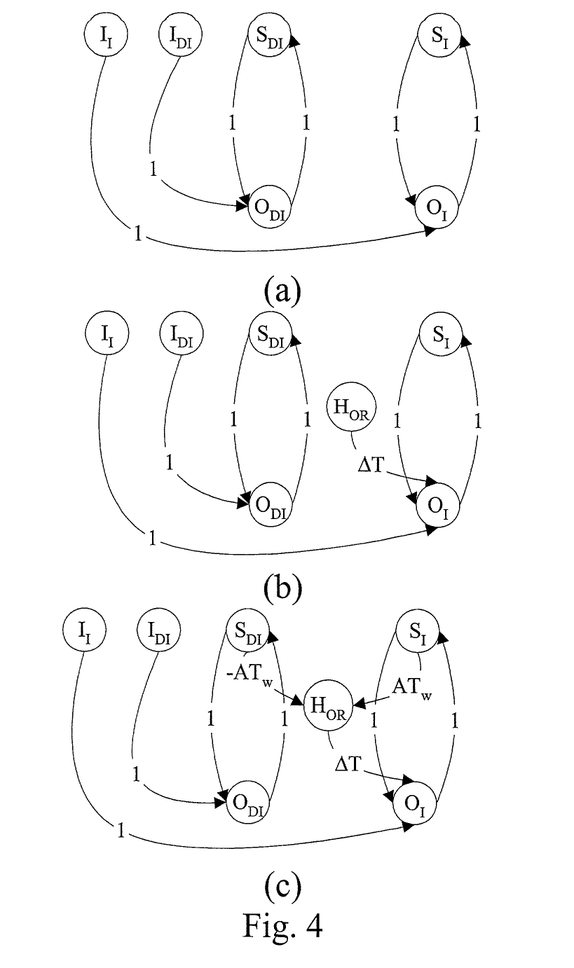

If the FD given in FIG. 1 is used as an example, then the output of the FD2PRN algorithm will be like the one shown in FIG. 4(c); the relationships of the corresponding components between the two models described above are listed in Table 2. As shown in FIG. 4(a), level (inventory: I) and constant (desired inventory: DI) are mapped to three units: input I_{I}, output O_{I}, state S_{I} and input I_{DI}, output O_{DI}, state S_{DI}, respectively. Rate (order rate: OR) is mapped to hidden unit H_{OR}, and the flow is mapped to the link from H_{OR} to O_{I}, as shown in FIG. 4(b). The other type of constants (adjust time: AT) that appear as coefficients in the rate equations is mapped to the weights of the links from S_{I} to H_{OR} and S_{DI} to H_{OR}, as shown in FIG. 4(c).

TABLE 2
The component mappings between a FD and a PRN.

| Components in FDs | Components in PRNs |
|---|---|
| Level variable, constant (not for | A triple of input, output, and state units |
| coefficient) | |
| Rate (or auxiliary) variable | Hidden unit |
| Wire | Link from a state unit to a hidden unit |
| Flow | Link from a hidden unit to output unit |
| Level equation | A weighted sum of output values from |
| | the hidden and state units connected to |
| | an output unit via links |
| Rate equation (including con- | A weighted sum of output values from |
| stants as coefficients) | the state units connected to a hidden |
| | unit via links |
| Equation for initial value | Link from an input unit to an output |
| | unit |
| Constant equation | Link from a state unit to an output unit |

Not shown in the figure are the values of the output units, which are determined by their net inputs as well as by the activation functions inside. So are the outputs of hidden units (corresponding to rates in FDs). Each unit expresses an equation in a way similar to that in a FD. The formulae for the PRN shown in FIG. 4(c) are as follows (proofs will be provided in later sections):

O_{I}(t)=O_{I}(t−1)+H_{OR}(t−1)×ΔT

H_{OR}(t−1)=(⅕)×[O_{DI}(t−1)−O_{I}(t−1)]

O_{DI}=6000

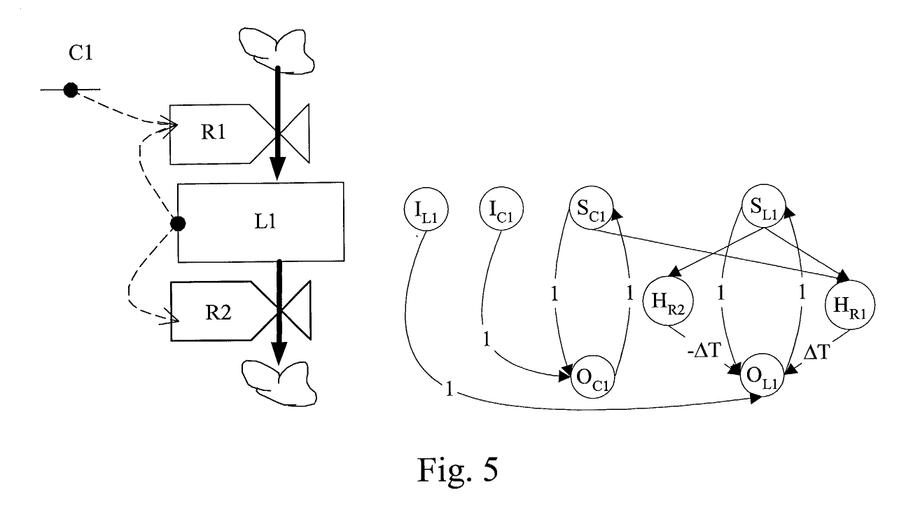

Notice that in FIG. 1 an information source (level or constant) is connected to only one rate on a flow into or out of a level. So, in the corresponding PRN, there is also only one path from a state unit (e.g., S_{I} or S_{DI}) via a hidden unit (e.g., H_{OR}) to an output unit. However, this is not always the case. For some other FD, an information source may link to both rates on flows into and out of the same level (e.g., FIG. 5). In the corresponding PRN, there are two paths from the state unit to the output unit, which together generate a net effect on the target. These two paths is called a link pair hereafter, and it will be explained in more detail in Section 3.4.

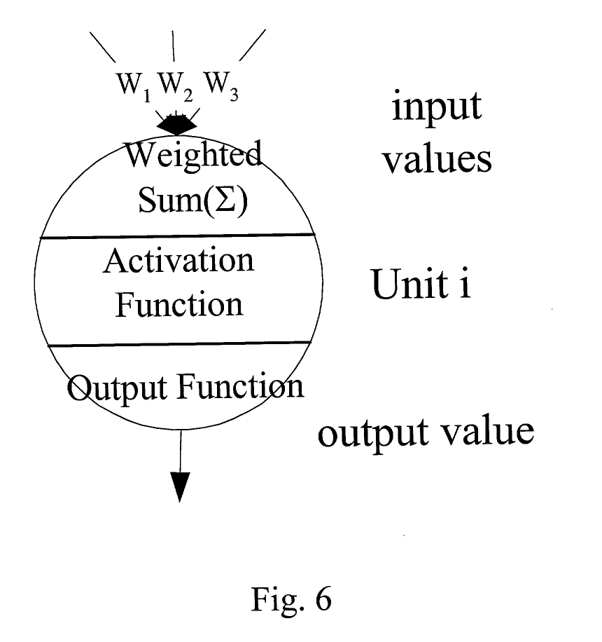

As shown in FIG. 6, values propagated to unit i through incoming links from other units are weighted and summated, and the result is called the net input of unit i. The output value of unit i is then calculated from the net input by the activation function and the output function. In this invention, the “identity function” is used as the activation function and the output function, which means that the output value of the unit will be the same as its net input.

2. Equivalence Proving

We are now ready to show mathematically that the two models involved in a transformation are equivalent. According to Dolado [Dolado, J. J. “Qualitative Simulation and System Dynamics,”System Dynamics Reviews (8:1), 1992, pp. 55-81], a FD represents a set of numeric propagation constraints, in which the intrinsic part is composed of the internal equations of levels and rates while the extrinsic part is composed of the initial values of constants and levels. On the other hand, the intrinsic constraints of an ANN are defined by the internal activation function of each unit and the weights on links between two units, while the extrinsic constraints are network inputs. If the constraints of the two models can be shown to be equivalent, then they will operate and propagate numeric constraints in the same way with no difference. In the following, the equivalence of each individual constraint is analyzed and proved.

2.1. Level Equations

Forrester [Forrester, J. W. Principles of Systems, MIT Press, Cambridge, Mass., 1968] defines a level equation as “a reservoir to accumulate the rates of flow that increase and decrease the content of the reservoir”. Thus the final value of a level represents that accumulation of the changes within a certain time period. A level equation in Forrester's form (Eq. 1) can be rewritten in a more easily understandable form:

$$L ( t ) = L ( t - 1 ) + Δ T ( {\sum }_{i = 1}^{m} {r}_{i} ( t - 1 ) - {\sum }_{j = 1}^{n} {r}_{j} ( t - 1 ) ) , \\ t = 0 , 1 , 2 , … , n \qquad ( Eq . 2 )$$

where

L is the level

L(t) is level L's new value at time t,

L(t−1) is level L's old value at time t−1,

ΔT is the time interval of the calculation,

rᵢ is the rate of an inbound flow into the level,

rᵢ(t−1) is the rate value between time t−1 and t,

m is the number of rates of the inbound flow into the level,

rⱼ is the rate of an outbound flow out of the level,

rⱼ(t−1) is the rate value between time t−1 and t, and

n is the number of rates of the outbound flow out of the level.

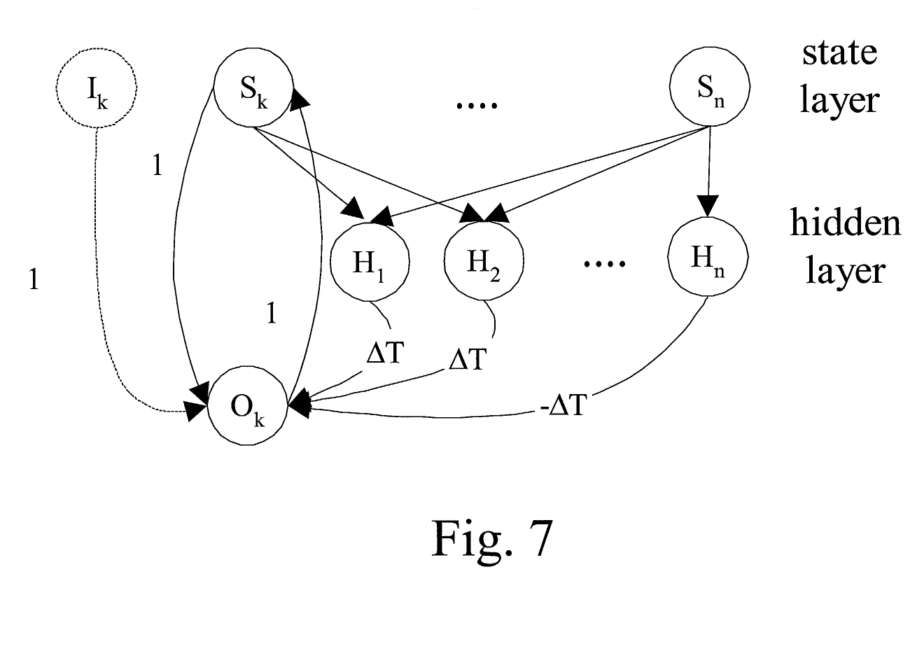

FIG. 7 shows the mapping between a level equation and the corresponding part in a PRN. A level corresponds to an input unit, a state unit, and an output unit, respectively, in a network. These units represent a model's input and output, i.e., their behavior as observed from the outside world. A rate corresponds to a hidden unit because its function is to propagate numeric values internally, similar to the meaning of a rate. A level equation is referred to the value of an output unit, which is determined by a weighted sum of output values from the hidden and state units connected to the output unit via links. The equivalence of this part of numerical constraints between the two models is shown in the following. Let us start from the output function of an output unit, which is

aₖ(t)=I(netₖ(t)) (Eq. 3)

where

aₖ(t) is the output value of the k^{th} output unit at time t,

netₖ(t) is the net input to the k^{th} output unit at time t, and

I( ) is the identity function.

The net input netₖ (t) is calculated as follows:

$${net}_{k} ( t ) = {\dot{w}}_{k} {I}_{k} ( t ) + {\ddot{w}}_{k} {S}_{k} ( t ) + {\sum }_{h} {w}_{hk} {H}_{h} ( t ) \qquad ( Eq . 4 )$$

where

netₖ(t) is the net input for the k^{th} output unit at time t,

k is the index of the k^{th} output unit (also corresponding to the k^{th} level),

wₖ is the weight of the link from k^{th} input unit to k^{th} output unit,

Iₖ(t) is the k^{th} input unit's output value at time t,

\ddot{w}ₖ is the weight of the link from k^{th} state unit to k^{th} output unit,

Sₖ(t) is the k^{th} state unit's output at time t,

h is the index of the h^{th} hidden unit (also corresponding to the h^{th} rate),

wₕₖ is the weight of the link from the h^{th} hidden unit to the k^{th} output unit,

and

Hₕ(t) is the h^{th} hidden unit's output at time t.

Close examination of FIG. 7 reveals that the incoming links connecting an output unit are divided into two groups: (1) from input or state units and (2) from hidden units. The former set of links is always assigned with a weight equal to one, so that the initial input values are propagated to output units directly and then are forwarded to state units. After that, the values of state units are used as a new set of inputs that feed in again to propagate to output units, and this process repeats at each time interval to ensure that the previous system outputs are kept. This part of mapping corresponds to the levels that accumulate old values in the last step. The weights of links from hidden units to an output unit are assigned to either ΔT or −ΔT, so that the product values represent the net changes of rate values into output units. One can now substitute these weight values into Eq. 4 to simplify the equation:

$${net}_{k} ( t ) = {I}_{k} ( t ) + {S}_{k} ( t ) + Δ T ( {\sum }_{i} {H}_{i} ( t ) - {\sum }_{j} {H}_{j} ( t ) ) , \\ i \neq j ⋀ t = 0 , 1 , 2 , … , n \qquad ( Eq . 5 )$$

where

netₖ(t) is the net input for the k^{th} output unit at time t,

k is the index of the k^{th} output unit (also corresponding to the k^{th} level),

Iₖ(t) is the k^{th} input unit's output value at time t,

Sₖ(t) is the k^{th} state unit's output at time t,

ΔT is the weight,

i is the index of the i^{th} hidden unit (also corresponding to the i^{th} rate of the inbound flow into the level),

j is the index of the j^{th} hidden unit (also corresponding to the j^{th} rate of the outbound flow out of the level),

Hᵢ(t) is the i^{th} hidden unit's output at time t, and

Hⱼ(t) is the j^{th} hidden unit's output at time t.

Input Iₖ(t) is also restricted to carrying values only at step 0 and is reset to zero otherwise. (The reason for this and the method used will be described in the next section.) In contrast, Sₖ(t), Hᵢ(t), and Hⱼ(t) will receive a zero value only at step 0, and any values after that. In addition, Sₖ(t) represents the current value of a state unit at time t as well as the output value of an output unit at time t−1. Substituting these values into Eq. 5 results in the following:

netₖ(0)=Iₖ(0) (Eq. 6-1)

$${net}_{k} ( t ) = {net}_{k} ( t - 1 ) + Δ T ( {\sum }_{i} {H}_{i} ( t ) - {\sum }_{j} {H}_{j} ( t ) ) , \\ i \neq j ⋀ t = 1 , 2 , … , n \qquad ( Eq . 6 \text{-} 2 )$$

where

netₖ(t) is the net input for the k^{th} output unit at time t,

k is the index of the k^{th} output unit (also corresponding to the k^{th} level),

Iₖ(t) is the k^{th} input unit's output value at time t,

netₖ(t−1) is the net input for the k^{th} output unit at time t−1,

ΔT is the weight,

i is the index of the i^{th} hidden unit (also corresponding to the i^{th} rate of the inbound flow into the level),

j is the index of the j^{th} hidden unit (also corresponding to the j^{th} rate of the outbound flow out of the level),

Hᵢ(t) is the i^{th} hidden unit's output at time t, and

Hⱼ(t) is the j^{th} hidden unit's output at time t.

The analyses above have shown that the Forrester's form of level equations (Eq. 1) can be rewritten into a general form (Eq. 2), while the output functions for a PRN can also be expressed as Eqs. 6-1 and 6-2. On the condition that t>0, Eqs. 2 and 6-2 are identical. This implies that the numeric constraints defined in a level equation can be re-implemented in a PRN designed as above.

2.2. Initialization Equations

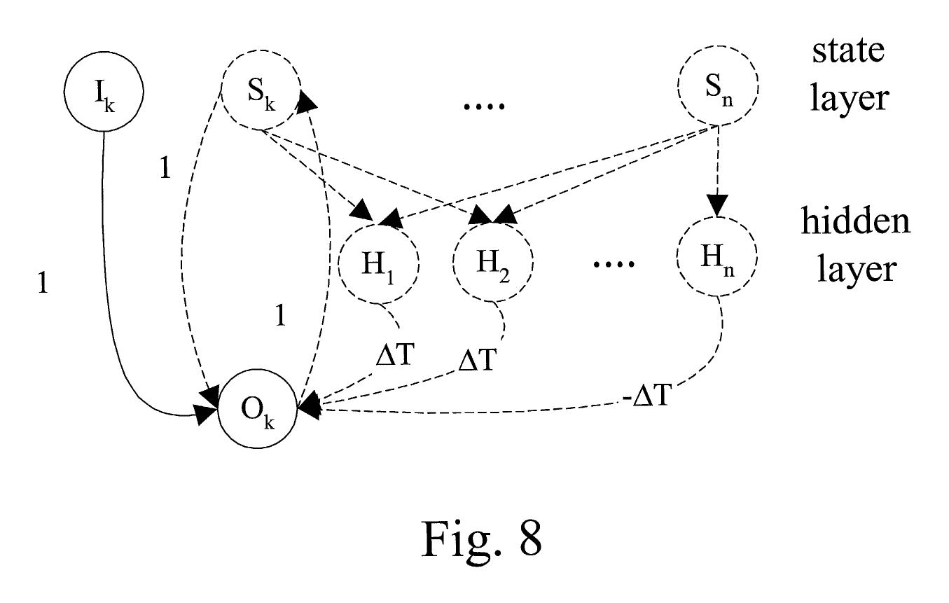

In the previous section it was shown that each input unit at step 0 propagates its value to the corresponding output unit, which in turn assigns an initial value of a level (FIG. 8). In the subsequent steps, however, a PRN can still allow the input units to feed new values into the network. This is different from the situation in a FD, where each level is set to an initial value by an initialization equation before a simulation starts, and then let the numeric values alone propagate in the simulation process without any interference from the outside world [e.g., Forrester, J. W. Principles of Systems, MIT Press, Cambridge, Mass., 1968]. (There are exceptions when a model constructor wants to manipulate some system variables or add noisy data to the system.) To mimic this behavior, one has to restrict the input units of PRNs so that they do not receive more data from the outside world after step 0. This requirement is achieved by a special arrangement of training cases in a data set, in which only the training tuple for step 0 is given initial values, while others in the following steps all receive zero values in the input part.

2.3. Constant Equations

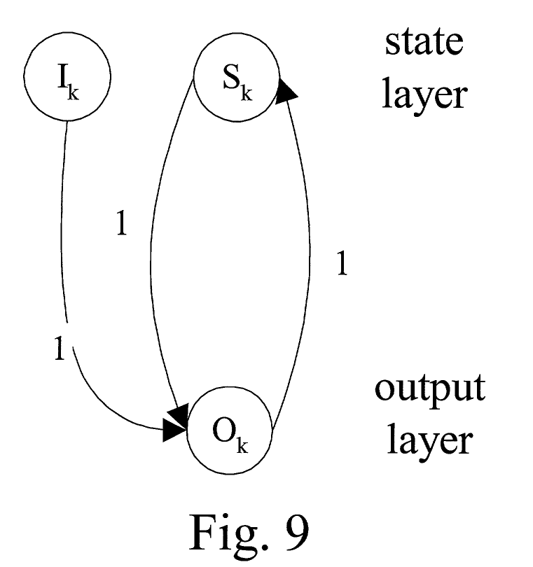

In a FD, all constants are assigned values by constant equations [e.g., Forrester, J. W. Principles of Systems, MIT Press, Cambridge, Mass., 1968]. In the algorithm FD2PRN, however, constants that do not appear as coefficients in a rate equation are treated as levels, as shown in FIG. 9. They are different from a normal level only in that they are connected with no hidden unit, and do not change values in simulation. Thus the equivalence proving is the same as that used for a level.

2.4. Rate Equations

A rate equation defines how a flow is controlled. It accepts inputs from levels or constants and generates an output that, in turn, controls a flow into or out of a level. A rate equation in Forrester's format is

R.KL=ƒ(all levels and constants) (Eq. 9)

where

R.KL is the rate value in time interval KL.

The above equation can also be rewritten in a more general format as

r(t)=ƒ(L_{I}(t), . . . , Cⱼ, . . . ), i=1, 2, . . . , m, j=1, 2, . . . , n (Eq.10 )

where

r(t) is the rate value between t and t+1,

ƒ( ) is any function,

Lᵢ is level I,

Lᵢ(t) is the level value at time t,

m is the number of levels,

Cⱼ is the constant I, and

n is the number of constants.

A rate equation can take any format, with some restrictions: (1) an equation cannot contain constant DT; (2) the right-hand side of an equation should not include other rate variables, but only levels and constants; and (3) the left-hand side of an equation contains the rate variable being defined by the equation. An additional constraint to be noted is that the value of a rate variable is only affected by the outputs of levels in the previous time interval in a FD. Therefore, a level value within function ƒ in the above equation is the old value of that level in the previous time step.

Since rates are mapped to hidden units in which the input links come from state units, the three restrictions for rate equations are enforced because: (1) DT is only assigned to links from hidden units to output units, which has nothing to do with links from either input or state units to hidden units; (2) there is no connection between any two hidden units, so no part of a rate equation will be represented by another; and (3) the output of a hidden unit itself represents a corresponding rate value. As to the last restriction, the only inputs of a hidden unit are from state units according to the algorithm FD2PRN. If a state unit has come from the mapping of a level, then the state unit keeps the value of a level in the previous time step, which satisfies the constraint; otherwise it is from a constant (which does not change value in time), and the constraint is satisfied trivially.

Besides the restrictions imposed on the rate equation, there is an additional consideration in the implementation of a PRN. From the point of view of the representation, there is no problem in the model mapping. But a rate equation can be any arbitrary function, and so it suffers a limitation if it has to be faithfully re-implemented in its original form in a PRN. That is, some functions cannot be trained in a PRN. As a requirement of a neural learning algorithm, an activation function has to be smooth and continuous in order to calculate its derivative value during a training process. Those functions (e.g., a look-up table) that do not satisfy the condition can exist in a PRN, but they will not participate in the learning process. However, this type of function is usually provided with certain by a human constructor and occupies only a small portion in a model. The most common rate equations are those that include only levels and constants in a weighted-sum format. This is illustrated as follows. An arbitrary weighted-sum equation may take the following form:

r(t)=a₁L₁(t)+b₃C₃ (Eq. 11)

where

r(t) is the rate value between t and t+1,

L₁ is the level 1,

L₁(t) is the level value at time t,

a₁ is the coefficient of L₁,

C₃ is the constant 3, and

b₃ is the coefficient of C₃.

The equation for r(t) that corresponds to the output of unit k is

$${net}_{h} ( t ) = {\sum }_{i = 1}^{m} {u}_{ih} {L}_{i} ( t ) + {\sum }_{j = 1}^{n} {v}_{jh} {C}_{j} ( t ) , i \neq j \qquad ( Eq . 12 )$$

where

netₕ(t) is the output for the h^{th} hidden unit at time t,

h is the index of the h^{th} hidden unit (also corresponding to the h^{th} rate),

uᵢₕ is the weight of the link from the i^{th} state unit to the h^{th} hidden unit,

Lᵢ(t) is the i^{th} state unit's output at time t (also corresponding to the i^{th} level's value at time t),

vⱼₕ is the weight of the link from the j^{th} state unit to the h^{th} hidden unit, and

Cⱼ(t) is the j^{th} state unit's output at time t (also corresponding to the i^{th} constant's value).

Let uᵢₖ=0 for i=2,3, . . . ,m, and vⱼₖ=0 for j=1,2,4, . . . ,n. Then Eq. 12 becomes:

netₕ(t)=u₁ₕL₁(t)+v₃ₕC₃(t) (Eq. 13)

where

netₕ(t) is the output for the h^{th} hidden unit at time t,

h is the index of the h^{th} hidden unit (also corresponding to the h^{th} rate),

u₁ₕ is the weight of the link from the 1^{st} state unit to the h^{th} hidden unit,

L₁(t) is the 1^{st} state unit's output at time t (also corresponding to the 1^{st} level's value at time t),

v₃ₕ is the weight of the link from the 3^{rd} state unit to the h^{th} hidden unit, and

C₃(t) is the 3^{rd} state unit's output at time t (also corresponding to the 3^{rd} constant's value).

One can see that the form of the rate equation of Eq. 11 is identical to that of Eq. 13. For rate equations in a product form, the result will be similar.

3. Model Construction

We are now ready to see how the new representation (i.e., PRN) can be applied to solving problems in a SDM. Let us consider an application that makes use of the learning capability of an ANN to assist model construction. Examples on how to create a SDM have appeared in various published articles. The following analysis will take the method from Forrester [Forrester, J. W. “System Dynamics, Systems Thinking, and Soft OR,” System Dynamics Review (10 :2-3), 1994, pp. 245-256] as an example for discussion and comparison. For other related work, please refer to Starr, P. J. “Modeling Issues and Decisions in System Dynamics,” TIMS Studies in the Management Science (14), 1980 , pp. 45-59; Randers, J. “Guidelines for Model Conceptualization,” in Elements of the system dynamics method Randers, J. (eds.), MIT Press, Cambridge, Mass., 1980 ; and Roberts, N. et al., Introduction to Computer Simulation: The System Dynamics Modeling Approach, Addison-Wesley, Reading, Mass., 1983.

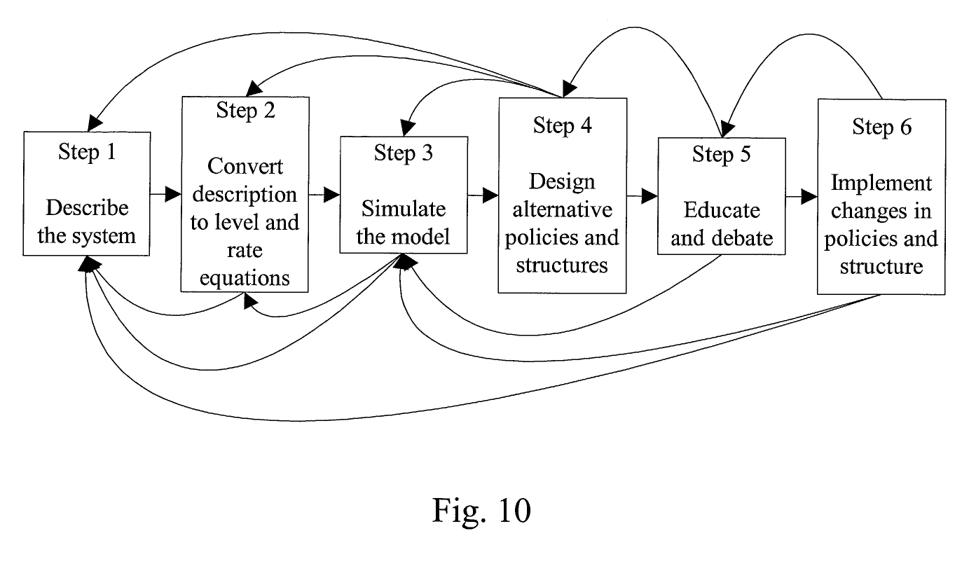

Forrester's method consists of six steps in the procedure of model construction: describe the system, convert the description to level and rate equations, simulate the model, design alternative policies and structures, educate and debate, and implement changes in policies and structure, as shown in FIG. 10 . The initial step identifies (or defines) the system boundary, describes the behavior of the system, and assumes the cause-effect relationships underlying this behavior. The second step begins to derive the possible equations based on the assumptions of the cause-effect relationships, and converts them into level or rate equations. Step 3 simulates iteratively to verify and refine the model created, and back to the last step if necessary; this step should be able to show how the actual behavior patterns are generated from the model. With a good model now constructed, step 4 designs alternative policies in order to change the system's behavior. Possible alternatives might come from intuitive insight, the analyst's experiences, an operational employee's suggestion, or by an automatic algorithm. Step 5 is for education. Its purpose is to gain consensus about the new policy to be implemented. It is a challenge to the leadership and coordination of managers. Finally, the last step is to implement the new policy. Problems may arise if imperfect implementation is performed in previous steps. In this step, old policies are ruled out and new policies are replaced. Forrester also addressed the existence of active recycling between each step and its previous step, as shown in FIG. 10 .

In order to make use of the automatic learning capability of a PRN, a process that integrates the neural learning method within the above construction process is defined. For ease of explanation, it is compared with Forrester's process in Table 3. Note that phases 2, 3, and 4 in the new process correspond to phases 2 and 3 in Forrester's one, and phases 5 and 6 of Forrester's process for policy implementation have no correspondence in the new process.

TABLE 3
The corresponding phases between Forrester's process
and ours.

| Forrester's process | New process |
|---|---|
| 1. Describe the system | 1. Problem Definition |
| 2. Convert description to level and rate equations | 2. Model Preparation |
| 3. Simulate the model | 3. Structure Learning |
| | 4. Model Interpretation |
| 4. Design alternative policies and structure | 5. Policy Design |
| 5. Educate and debate | No corresponding |
| 6. Implement changes in policies and structure | |

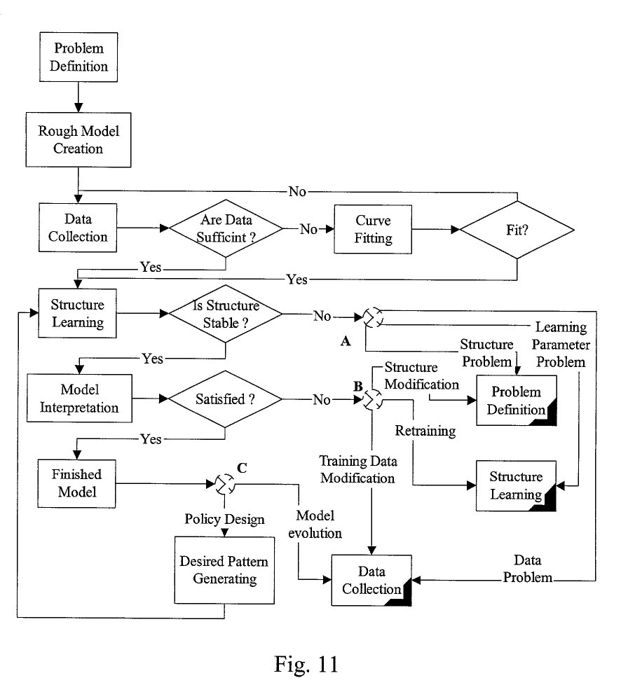

The flow chart of this new construction process is shown in FIG. 11, which can be considered a revision of the Forrester one shown in FIG. 10. However, the new process considers only the first four phases, and ignores the last two since they are irrelevant to the subject of this invention. The former part is expanded into five phases: (1) problem definition, (2) model preparation, (3) structure learning, (4) model interpretation, and (5) policy design. In the following, these five process steps relating to neural learning are described to see how the capability is integrated into the construction process.

3.1. Problem Definition

To create a good model is to solve a problem. So, one needs first to give a clear problem definition. That is why most model construction processes identify this one as the first phase. This phase has been given several names, such as problem definition [Starr, P. J. “Modeling Issues and Decisions in System Dynamics,” TIMS Studies in the Management Science (14), 1980 , pp. 45-59 and Roberts, N. et al. Introduction to Computer Simulation: the System Dynamics Modeling Approach, Addison-Wesley, Reading, Mass., 1983], conceptualization [Randers, J. “Guidelines for Model Conceptualization,” in Elements of the system dynamics method Randers, J. (eds.), MIT Press, Cambridge, Mass., 1980 ], and describing the system [Forrester, J. W. “Industrial Dynamics—After the First Decade,” Management Science (14:7), 1968, pp. 393-415]. We consider that the naming scheme adopted by Starr and Roberts is the clearest.

According to Starr [Starr, P. J. “Modeling Issues and Decisions in System Dynamics,” TIMS Studies in the Management Science (14), 1980 , pp. 45-59], the following will be defined in this phase: model purpose, boundaries, relative variables, and validation attitude. A constructor should focus on the comprehension of various observable entities and the operation procedures on top of these entities. These entities are usually tangible (and perceivable) in a real system, and most of them are not changeable. The constructor needs only to abstract them into levels or flows and add them to the model based on his or her experiences. There is not much that can be automated.

The only difference of this phase with those of other processes is in the requirement for cause-effect relationships. Traditional processes will require the knowledge of the behavior of variables as well as the assumption of cause-effect relationships among these variables. Our approach, on the other hand, relies on the ANN learning mechanism to identify the cause-effect relationships; there is no need to assume anything manually, which greatly simplifies an otherwise painstaking procedure.

In practice, the procedure described above may not necessarily start from scratch. An experienced model constructor will usually use some pre-built model pieces when assembling an initial model. This in turn means that some predefined structure patterns exist within the initial PRN. This is an advantage to our construction process since it will help a created PRN to learn faster and converge more rapidly to a meaningful SDM.

3.2. Model Preparation

The conceptual structure created in the last phase shall be rephrased here in terms of a PRN representation. A constructor may initially create a model in a FD, and later map it into a PRN using the FD2PRN algorithm. (Or s/he can directly represent the model as a PRN if s/he would like to.) At this stage the model is incomplete since the cause-effect relationships may be missing; there are only levels, flows (between levels), rates (on flows), and constants, but the wires are missing.

To avoid losing any possible relationship, one can filly connect each pair of units between the state layer and the hidden layer; that is, to assume that all levels have an effect on all rates. This is of course not without flexibility. If a constructor already knows that some relationships do not exist, the corresponding links can be removed (e.g., when pre-built model pieces are included). The initial weights on these links are assigned randomly or arbitrarily, which will be adjusted later during the training process. The weights on other links (e.g., those corresponding to flows or initialization) are not adjustable. Moreover, there is only one layer of hidden units here. This means that auxiliary variables are not separated from rate equations in this phase; this task is deferred until the phase of model interpretation.

Wires represent the concept of information feedback, which exists only in a person's mental model and is therefore intangible. Traditional approaches of identifying these wires are based on a human constructor's logic inference ability to trace through an enterprise's management policies and/or managers' mental models in order to derive the possible feedback structures in a system. Thus, it is a process of deduction. The difficulty is that there are no systematic guidelines or observable (system) objects that can be used to compare with the logical conclusions drawn by the constructor. Collected data that is of poor quality or is incomplete may further undermine this approach. Therefore, this forms a tedious trial-and-error part of the model construction.

The invention described here, however, uses an induction process. After an initial PRN structure is created, one can then use the training data set to extract a complete information feedback structure by using a learning process. This makes it a process of induction based on evidence. When the induced structure is augmented with a meaningful human interpretation, it will be a more rigorous method than the traditional approach. Other benefits will be described later.

3.3. Structure Learning

In operation, an ANN does not need the data examples that are required during a learning phase. The examples serve merely as the behavior patterns for the network to be fitted. Thus, a good quality training data set is required before the learning process begins.

3.3.1. Data Collection

A training example for a supervised ANN consists of two parts: the inputs (stimuli) to the network and the outputs (responses) out of it. However, training examples used in this invention are a little different in that only the first training instance contains the inputs to the system while the instances that follow have all to be reset to zero. This is due to the characteristic that a SDM requires only an initial set of inputs to operate. The second (i.e., output) part of the training examples represents the physical values of levels obtained at each time step from a system, and they have to be given in chronological order, since what a PRN learns is this output time series pattern. The data to be collected should have already been determined in phase one, when boundaries of the system and related variables are defined.

The number of training examples required depends on the complexity (i.e., the number of weights to be adjusted) of the PRN to be trained, and there is no general rule for this. However, a heuristic method has been described in Winston, P. H. Artificial Intelligence, Addison-Wesley, Reading, Mass., 1992, which dictates that the number of training examples cannot be less than the number of weights to be adjusted. If the data collected already satisfy this requirement, one can directly enter the training process. However, the model to be constructed is usually very large in practice, which would result in a relatively large number of links to be adjusted. Therefore, it is necessary to consider the case where the number of training examples from a problem domain is insufficient.

In the numerical analysis area, there is an approximation theory that studies two general types of problems [e.g., Burden, R. L., and Faires, J. D. Numerical Analysis, Prindle, Weber & Schmidt, Boston, 1985]. One of these relates to finding a function of a certain class that will best fit a set of given data points. Many methods have been proposed to solve this problem. Since our purpose is to find more data examples for a variable with respect to time, the approximation theory is applicable. The idea is the following. Given a set of data points, find an approximate function that is the best fit to them, and then use this function to generate as many extra data points as are necessary for the learning process. The method suggested here is only for assistance; model constructors should always attempt to collect more real data instead.

There is one more thing to be noted in the preparation of training examples. For a PRN in action, an input data value is multiplied by a weight and then forward propagated. In the iteration of many time steps, a data value is in fact multiplied in an exponential order. Therefore, if the initial value is greater than one, this procedure may create a numerical overflow. Thus the input values have to be set within the range between −1 and 1. A simplest way is to divide all the original values by 10ⁿ where n is the logarithm of the largest data value. After the training data set is prepared, one can start the training process according to the following procedure.

3.3.2. Training a Network

The learning method to be used here is a revised back-propagation algorithm modified to fit with a type of PRN that has the following properties: (1) after the deletion of all state units and associated links, the remaining network has a simple feed-forward architecture with no feedback loops; (2) input units must not receive input from other units; (3) output units may only have outgoing connections to state units; and (4) every unit, except the input units, has to have at least one incoming link. Every network that satisfies these restrictions can be trained using the revised back-propagation learning method. The method treats state units as another source of inputs; i.e., the network consists of two input channels. One is for training data input (i.e., the system's input) and the other is for state units that maintain values from the previous time step. In this way, the structure of a PRN is analogous to a simple feed-forward network, and a back-propagation algorithm can be modified to training such a PRN. Please refer to Zell, A. et al. SNNS User Manual Version 4.1, University of Stuttgart, Stuttgart, Germany, 1995, for details of the algorithm.

To complete the training process, there are still some details to consider: which back-propagation learning algorithm to use and how to set its parameters. The three types of well-known algorithms are standard, momentum, and quick back-propagation. Standard back-propagation has three parameters, whereas momentum back-propagation and quick back-propagation both have five parameters. In order to avoid any irrelevant factor that may reduce the performance during learning, the algorithm of standard back-propagation is adopted since it requires the least number of parameters. The parameters are η (learning rate), dₘₐₓ (maximum difference), and t (teaching forcing). η specifies the step width of the gradient descent during the learning process. Learning is faster when η is larger, but the network structure may become unstable during learning when it is too large. A common guideline is to start with η=0.1 and then gradually adjust its value. dₘₐₓ means the maximal tolerable difference between a teaching value and a real output of an output unit, and it is usually set 0 (which means fully matched). t is a ratio parameter that specifies how the output units propagate to the successor state units with a combination of the teaching outputs and the real outputs during the training phase. The value of t ranges between 0 and 1. If it is 0 , only the teaching output is propagated; if it is 1, the real output is propagated. A value between 0 and 1 yields a weighted sum of the teaching output and the real output. In this invention, t is set to 1.

In the end of training, a network may or may not converge to a stable structure. If it does not, this means that the network does not fit into the given set of training data, which may be caused by factors such as an inappropriate initial network structure or a poor quality training data set. It is not possible for the model constructor to identify which factor is responsible for the lack of convergence. S/he needs to investigate each possible cause and the solution for fixing it, as is shown in the diagram of FIG. 11. Let us discuss them in the following:

1. Learning rate problem: η (learning rate) is set too large. As mentioned earlier, a large η can speed up learning but it may cause a network structure to become unstable that missing the best optimal solution. In this case, one needs to decrease η and redo the learning process.

2. Initial structure problem: (a) it has an insufficient number of levels, rates, or flows, i.e., the boundaries of a model are incorrect; or (b) flows between levels are incorrect. (This problem is similar to the “model validation” in traditional approaches.) A constructor has to review the model to determine where the problem lies. The process therefore re-enters phase one in which it is necessary to: (a) define the correct boundaries of the model and find missing levels, rates or flows; and/or (b) adjust flows between levels.

3. Training data problem: (a) the given data might be selected from a transient period in which a system is unstable; or (b) many noises exist in the training data set, and it requires preprocessing. Some possible solutions to this problem are: (a) partition the data set so that all training examples come from a stable system, or (2) filter out noise in the data set to determine the major function curve. Several methods exist to solve these types of problem, such as smoothing and Fourier transformation.

3.4. Model Interpretation

If the training process results in a stable network structure, then this is one (but not necessarily the only one) that the learning method determines whose output patterns best match the training data set. However, this is only a mathematical fit and the resulting structure is not always physically meaningful. A constructor needs to interpret the structure in order to verify the model. This is a unique phase in the process of the present invention against others. The constructor can use the reversed FD2PRN algorithm to interpret the structure of the trained network. Because the learning method adjusts the weights of only those links between the state and hidden layers, s/he only needs to interpret these links. Each of them represents a coefficient in some rate equation, and also the degree of the effect of an information source to a rate variable. As mentioned above, information sources are levels or constants. The identified links therefore represent the cause-effect relationships between variables, the so-called information feedback.

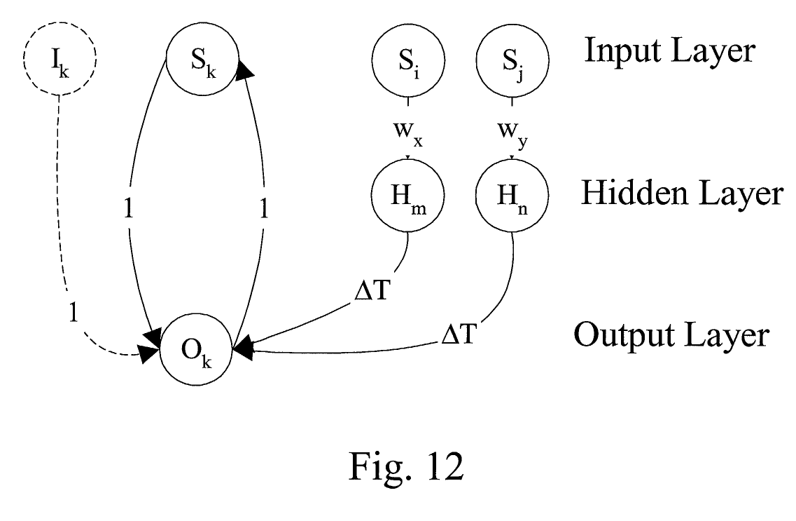

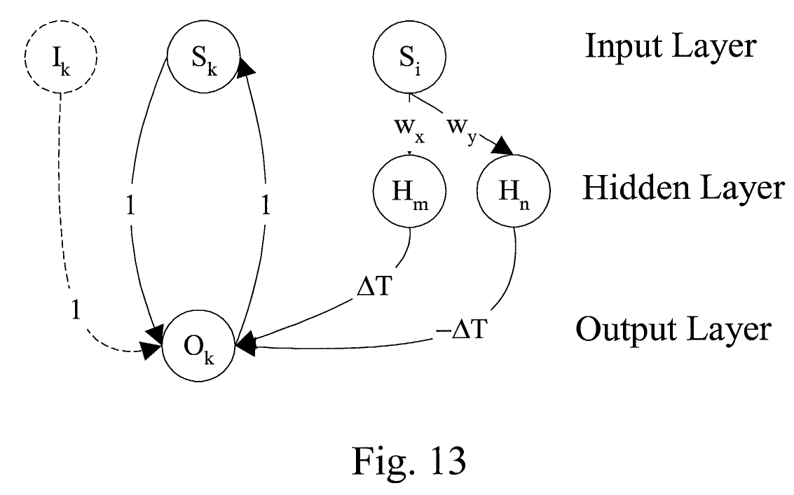

The adjustable weight on a link can be absolute or relative. It is “absolute with respect to an output unit” if the link is on the only path that connects the state unit to the output unit via a hidden unit. For example, weight wₓ (or w_{y}) on link Sᵢ-Hₘ (or Sⱼ-Hₙ) is absolute to Oₖ since there is only one path from Sᵢ (or Sⱼ) to Oₖ (via Hₘ), as shown in FIG. 12. The weight on a link is “relative to an output unit” if the state unit that the link connects to has more than one path to reach the output unit. The effect of Sᵢ to Oₖ is an example of this. It is determined by the net value of the summation of weight wₓ and w_{y} (i.e., wₓ-w_{y}); each single wₓ or w_{y} has no absolute meaning, as shown in FIG. 13.

These weights also represent the structure of a model. A nonzero weight indicates the existence of information feedback in the system, while a weight near zero represents the opposite. “Near” zero is a relative concept with no definite specification. Heuristic rules usually use 0.001 as a threshold, which is the one that was used here. The currently nonexistent links do not mean that their weights are useless; on the contrary, they might be useful for policy design in the next phase.

If a rate (i.e., a hidden unit) is connected to too many information sources, it may hinder the understanding of the system. One can therefore consider to single out the same type of levels within a rate equation (e.g., in-stock inventory, out-of-stock inventory, and ongoing inventory) into an auxiliary variable. However, this is better done after the model is converted back to a FD representation since it may create confusion if done in the PRN representation.

It is not always possible to obtain a satisfactory interpretation of the model. Sometimes a model constructor may not agree with the interpretation found, or even no such interpretation may exist. For this situation, s/he has three alternatives: (1) restart the training with the same initial structure and training examples; (2) return to phase one and recreate the initial structure; and (3) collect more training examples and prepare a new training data set. The three alternatives are not mutual exclusive; a model constructor can apply more than one alternative, as is shown at point B in the diagram of FIG. 11.

3.4.1. Redo the Training

ANN learning is a process of gradually approaching a target structure that best fits with the patterns given in the training example set; this process is called “hill climbing” in artificial intelligence. If the unfortunate situation exists in which all appropriate solutions are distributed around a contour, the process will not result in an optimal solution, as is discussed in the following two cases:

1. Foothill: the structure that an ANN has learned sits on top of a small hill (a so-called sub-optimal solution) with no better one surrounding it. It is therefore not possible to train the network further, and there exists no reasonable interpretation for the model. One way to get around of this situation is to increase the learning rate so that the adjustment of the network at each step uses a slightly larger jump in order to bypass a local solution. The other is to reset the initial assignments of weights to other values so that the search for an optimal solution restarts from a new initial point. (One can of course use the well-known approach called “simulated annealing” to avoid this problem if necessary.)

2. Plateau: in this case the structure that an ANN has learned is on a plateau; the other ones surrounded it are also optimal solutions but they do not necessarily have meanings. A feasible way to deal with this case is the same as above.

3.4.2. Change Structure

The situation and solutions is the same as those described in the last phase, where the process iterates back to the first phase to redo the conceptualization of the problem when one cannot find a stable structure for a network. The constructor, in this case, can add some new levels or flows into a stable but inappropriate structure or delete some unreasonable ones and redo the training.

3.4.3. Update Training Examples

An inappropriate structure can also be caused by training examples that are incomplete or poor quality. In this case, even though the network has converged to a stable structure that fits the examples, it is not necessarily a good representation of the system. A constructor should attempt to collect as much good data as possible to train the ANN again.

3.5. Policy Design

This is another place where the PRN representation of a SDM might be of help since this phase also involves identifying a new structure for a given system. In particular, it will be useful in determining “better parameter values” and “creating different linkages among system elements”, which are two of the three activities described in the policy design given in Starr, P. J. “Modeling Issues and Decisions in System Dynamics,” TIMS Studies in the Management Science (14), 1980 , pp. 45-59. This is shown at point C in the diagram of FIG. 11.

The method is also related to the learning capability of the PRN representation. Since it can learn the structure of a model from a set of historical data, it should also be able to learn from a set of new patterns derived from the intention of a human constructor. The problem is how to create the intended training data patterns. Depending on the type of a problem, if it is to search for a policy that will generate a stable trajectory, then it is sufficient to use a flat line as the training data set. Otherwise, the goal is to search for a policy that will generate a growing trajectory for a given model. The training data can be prepared either using an optimal algorithm [e.g., Burns, J. R., and Malone D. W. “Optimization Techniques Applied to the Forrester Model of the World,” IEEE Transaction on Systems, Man, and Cybernetics (4:2), 1974, pp. 164-171; Bailey, R., Bras, B. and Allen, J. K. “Using Response Surfaces to Improve the Search for Satisfactory Behavior in System Dynamics Models,” System Dynamics Review (16:2), 2000 , pp. 75-90 ] or generated manually by a domain expert.

As long as the behavior patterns are generated, the procedure can re-enter phase three and four in order to re-generate a new structure for the model. By comparing it to the original structure of the system, a model constructor will identify the changes of weights of links. A nonzero weight might change to another value, which corresponds to the first type of policy design—better parameters. There may also be links which originally had a “near” zero weight now become non-zeros. This means that a new connection appears which does not exist before. On the other hand, a nonzero weight may become “near” zero, which means a link is dropped. Both of these latter two cases correspond to the second type of policy design—creating a different linkage.

Extending the above results further, one can also make a constructed model evolve by giving it more training periodically (or intermittently) from the outside world, using the latest data to identify the changes that may occur after some period of time. A change may be a minor adjustment in some parameter, or else a drift in the structure, such as that occurs when a link appears or disappears. If the latter happens, one may need to trigger a mini-procedure of model construction to re-evaluate the latest model, and update it if the new structure has meaning. In this way, the model evolves over time.

4. Empirical Study

Is the proposed method feasible from a practical point of view? This issue is investigated in the following four steps associated with experiments. (1) Pattern regeneration: whether a FD and its corresponding PRN will generate exactly the same time series patterns. If they do, then the validity of the mappings between the two representations is verified, and the foundation of our method is established; (2) Learning effectiveness: whether the training process will physically generate a reasonable model structure. If it does, then the effectiveness of the automatic learning process has been shown; (3) Generalization: whether the learned system structure faithfully represents the behavior exhibited by the system, and not just fitting with the training examples; and (4) Scalability: whether the method will still work when a model becomes more complicated with additional levels and flows. If all of these issues reach a satisfactory result, the presented method will be practically applicable.

4.1. Pattern Regeneration

In the above, it is shown structurally and mathematically that a FD can be mapped to a specially designed PRN. The experiment here will physically examine and evaluate the validity of this claim. First, an arbitrarily selected FD is created using STELLA (which is a standard software package for the creation and simulation of FDs since its introduction in 1985 [Richmond, B., Vescuso, P. and Peterson, S., An Academic User's Guide to STELLA, High Performance System, Hanover, N.H., 1987]), and it is used to produce the output patterns of each level variable over a time interval. Meanwhile, the FD2PRN algorithm is used to create a corresponding PRN from this FD with a one-to-one mapping in structures. With this new representation, another set of time series patterns is produced which is compared against the original. There is currently no standard comparison method, so the criteria that are most frequently used in papers are adopted here (e.g., MSE, RMSE, MAE, MAPE, NMSE, and NRMSE—these quantities are defined below), to evaluate the regeneration performance of the PRN. These criteria are commonly used to estimate the correctness of forecasting [e.g., Nie, J. “Nonlinear Time Series Forecasting: A Fuzzy-neural Approach,” Neurocomputing (16), 1997, pp. 63-76; Zhang, G. and Hu, M. Y. “Neural Network Forecasting of the British Pound/US Dollar Exchange Rate,”Omega (26:4), 1998, pp. 495-506; Aussem, A. “Dynamical Recurrent Neural Networks towards Prediction and Modeling of Dynamical Systems,” Neurocomputing (28), 1999, pp. 207-232], and to measure the difference between a real value and an estimate of it. The equations are following:

$$MSE = \frac{\sum {( {y}_{t} - {\hat{y}}_{t} )}^{2}}{T}$$

$$RMSE = \sqrt{MSE}$$

$$MAE = \frac{\sum \vert {y}_{t} - {\hat{y}}_{y} \vert}{T}$$

$$MAPE = \frac{1}{T} \sum \vert \frac{{y}_{t} - {\hat{y}}_{t}}{{y}_{t}} \vert \times 100$$

$$NMSE = \frac{MSE}{{σ}^{2}}$$

$$NRMSE = \frac{RMSE}{σ}$$

where yₜ is an output of a FD, ŷₜ is the corresponding output of the PRN, t is the number of data points, and σ² is the variance of the output time series pattern. The first three criteria are a kind of mean values while the last three are normalized with respect to yₜ or σ, respectively.

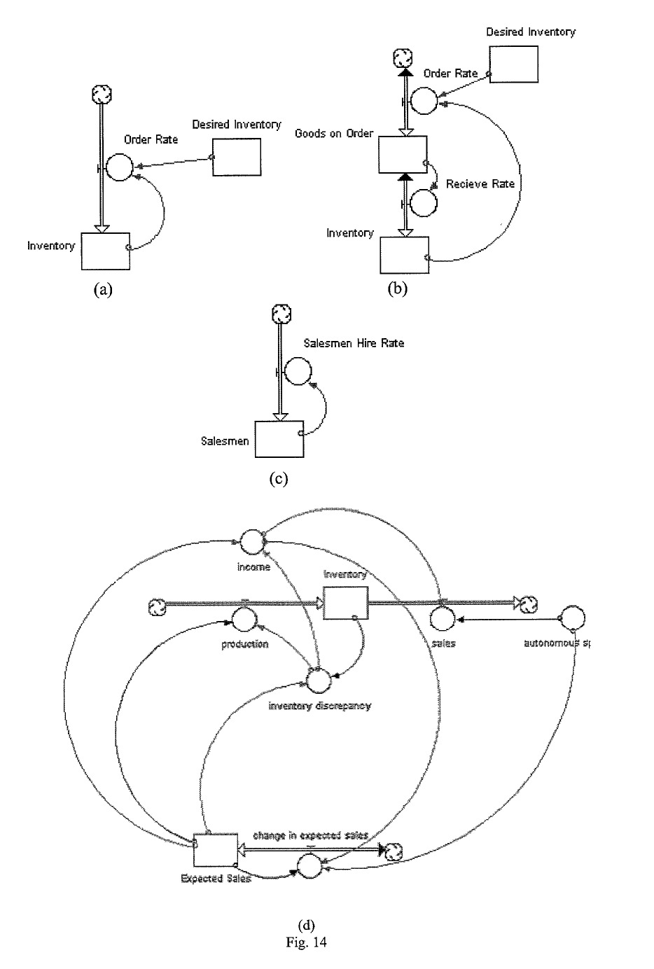

Four well-known SDMs are adopted in the experiments here, as shown in FIG. 14. The first three (FIG. 14(a)-(c)) are found in [Forrester, J. W. Principles of Systems, MIT Press, Cambridge, Mass., 1968] which were used to illustrate a first-order negative feedback loop, a second-order negative feedback loop, and a positive feedback loop, respectively. The first model (FIG. 1) is also used in this invention. The fourth one is modified from an example model (named “Business”) given in the library of STELLA, in which there are many positive and negative feedback loops intermixed together. The coefficient constants in these models are rewritten and incorporated into rate equations and other constants are changed into levels without inbound or outbound flows. These modifications shall not affect the behaviors of the models. The four models generate different numbers of output examples: 50 , 100 , 50 , and 100 , respectively (FIG. 14(a)-(d)). One example represents one DT time interval in a time series.

Table 4 shows the results of pattern regeneration of each of the four models. One can see that all of the criteria indices receive a tiny value (of the order of 10⁻⁶), which means that the regeneration patterns produced by the corresponding PRN are almost exactly the same as their original patterns, and that the new model is just another representation of the original one with the same structure. What is interesting from the results is that the regeneration effectiveness of a complicated model (e.g., model 4) is not necessarily worse than a simple one (e.g., model 3).

TABLE 4
The effectiveness of pattern regeneration by
PRNs (All values in this table
are multiplied by 10⁶).

| | Levels | MSE | RMSE | MAE | MAPE | NMSE | NRMSE |
|---|---|---|---|---|---|---|---|
| Model 1 | I | 0.00000006 | 0.24494897 | 0.06000000 | 0.10020955 | 0.00000516 | 2.27220024 |
| (FIG. 14a) | | | | | | | |
| Model 2 | I | 0.00000024 | 0.48989795 | 0.24000000 | 0.43631328 | 0.00001208 | 3.47628848 |
| (FIG. 14b) | GO | 0.00000030 | 0.54772256 | 0.30000000 | 31.93470574 | 0.00001026 | 3.20332483 |
| Model 3 | S | 0.00000032 | 0.56568542 | 0.32000000 | 3.25769262 | 0.00037884 | 19.46393932 |
| (FIG. 14c) | | | | | | | |
| Model 4 | I | 0.00000030 | 0.54772256 | 0.30000000 | 0.36676194 | 0.00011291 | 10.62581797 |
| (FIG. 14d) | ES | 0.00000025 | 0.50000000 | 0.25000000 | 1.34740232 | 0.00019029 | 13.79456641 |

The above observation hints that pattern regeneration has nothing to do with either the number of variables or the number of data points; it only has something to do with the structure. The experiment also shows that a special design PRN can faithfully regenerate the behavior of a corresponding SDM. Thus it has been proved in simulations that the FD2PRN algorithm for a FD does generate an equivalent PRN (although it has been proved structurally and mathematically before). The next task is to evaluate the training process to verify the learning capability of the new models.

4.2. Learning Effectiveness

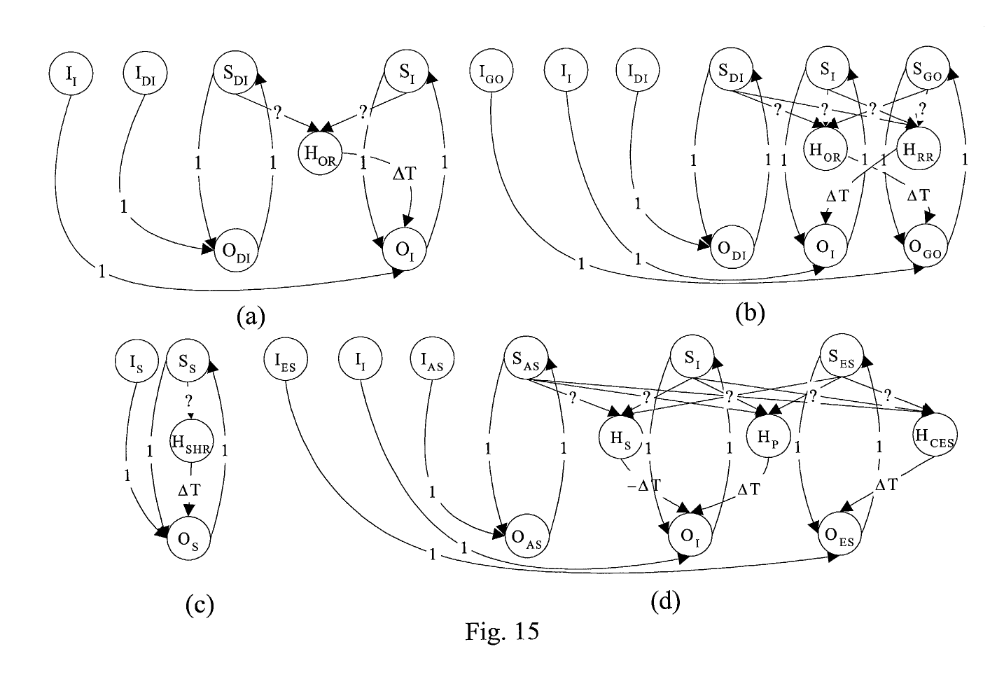

This experiment will continually use the four models adopted in the last experiment to investigate the learning capability of a PRN. According to phases one and two of our model construction process, one needs first to create an initial model for each of them without knowledge of the cause-effect relationships among variables. These are shown in FIG. 15, where there is only one layer of hidden units and they are fully connected to the units in the output layer. The numbers of links to be learned in each model are 2, 6, 1, and 9, which are marked with “?” labels in the diagrams. In the first three models, all links corresponding to wires carry absolute meanings, while, in the last model, only the links connected to H_{CES} have absolute meanings and others have relative meanings (refer to Section 3.4 for an explanation of this terminology). The training data are collected from the simulation results of each model implemented in STELLA.

TABLE 5
The learning process for model 1 with a learning rate of 0.1.

| | Epochs | | | | |
|---|---|---|---|---|---|
| Links | 1 | 50 | 100 | 150 | In FD |
| DI->OR | 0.07201 | 0.19778 | 0.19992 | 0.2 | 0.2 |
| I->OR | −0.09258 | −0.19779 | −0.19992 | −0.2 | −0.2 |
| SSE* | 1.302581548690 | 0.000032366260 | 0.000000042438 | 0.000000000063 | |

*SSE = Sum of Square Error

TABLE 6
The learning process for model 2 with a learning rate of 0.1.

| | Epochs | | | | |
|---|---|---|---|---|---|
| Links | 1 | 50 | 100 | 200 | In FD |
| DI->OR | 0.11011 | 0.21374 | 0.20021 | 0.2 | 0.2 |
| GO-> | −0.07076 | −0.00995 | 0.00013 | 0 | 0 |
| OR | | | | | |
| I->OR | −0.10091 | −0.21682 | −0.20033 | −0.\2 | −0.2 |
| DI->RR | 0.11052 | −0.01960 | −0.00025 | 0 | 0 |
| GO-> | 0.08630 | 0.11929 | 0.09987 | 0.1 | 0.1 |
| RR | | | | | |
| I->RR | −0.10843 | 0.02385 | 0.00043 | 0 | 0 |
| SSE | 4.030906200408 | 0.083232857286 | 0.000025431156 | 0.000000000038 | |

Tables 5-7 show the learning process of the first three models with a learning rate of 0.1. One can see that their learning results are almost perfect, with the weights to be adjusted gradually approaching the final target values and the weights on the nonexistent links all being reduced to near zero. The training of the three models completes at around the 150^{th}, 200^{th}, and 10^{th} epoch, respectively. Note that an epoch means that the network was trained on the entire set of training examples once in the learning process.

TABLE 7
The learning process for model 3 with a learning rate of 0.1.

| | Epochs | | | | |
|---|---|---|---|---|---|
| Links | 1 | 3 | 5 | 10 | In FD |
| S->SHR | 0.01248 | 0.01986 | 0.01998 | 0.02 | 0.02 |
| SSE | 0.107980273663 | 0.000050484439 | 0.000001129671 | 0.000000000084 | |

The data shown in Tables 8 and 9 are for training the network of model 4 with learning rates of 0.1 and 0.0 5, respectively. The learning effect is a little worse than for the first three models, but it is already very close to the target, and the three link pairs with relative meanings are also successfully learned in the structure. When the learning rate is 0.1, the training process ends at 10,000 epochs; for a learning rate of 0.05, it ends at 15,000 epochs.

TABLE 8
The learning process for model 4 with a learning rate of 0.1.

| | | Epochs | | | | Values in |
|---|---|---|---|---|---|---|
| | Links | 1 | 1000 | 5000 | 10000 | FD |
| 1 | ES->ESC | −0.10942 | −0.14061 | −0.09534 | −0.09688 | −0.09685 |
| 2 | I->ESC | 0.21019 | −0.27144 | −0.20974 | −0.21254 | −0.2125 |
| 3 | AS->ESC | 0.28022 | 1.39048 | 0.98466 | 1.00011 | 1 |
| 4 | ES->P | 0.61841 | 0.66777 | 0.62893 | 0.62969 | 1.0625 |
| 5 | I->P | 0.43406 | 0.58526 | 0.63217 | 0.63128 | −0.25 |
| 6 | AS->P | 0.62896 | 0.07293 | 0.25377 | 0.25072 | 0 |
| 7 | ES->S | 0.48159 | 0.43222 | 0.47107 | 0.47030 | 0.903124 |
| 8 | I->S | 0.86594 | 0.71474 | 0.66783 | 0.66873 | −0.2125 |
| 9 | AS->S | 0.87104 | 1.42707 | 1.24623 | 1.25072 | 1 |
| | 4-7 | 0.13682 | 0.23555 | 0.15786 | 0.15939 | 0.159376 |
| | 5-8 | −0.43188 | −0.12948 | −0.03566 | −0.03745 | −0.0375 |
| | 6-9 | −0.24208 | −1.35414 | −0.99246 | −1 | −1 |
| | SSE | 2.134996175765 | 0.019681053236 | 0.000089574292 | 0.000000019754 | |

The above results show that various kind of SDMs indeed can be learned by the given method, irrespective of whether a model contains positive (models 3 and 4) or negative (models 1, 2, and 4) feedback loops, is of high (models 2 and 4) or low (models 1 and 3) order, and is complicated (model 4) or simple (models 1, 2, and 3). The experiment also shows that the learning speed is dependent on the complexity of a model, especially when there are link pairs. From these experiments, it can be concluded that using a PRN to assist in the construction of a SDM is feasible and achievable.

TABLE 9
The learning process for model 4 with a learning rate of 0.05.

| | | Epochs | | | | Values in |
|---|---|---|---|---|---|---|
| | Links | 1 | 5000 | 10000 | 15000 | FD |
| 1 | ES->ESC | −0.09791 | −0.09770 | −0.09685 | −0.09687 | −0.09685 |
| 2 | I->ESC | 0.22023 | −0.21234 | −0.21251 | −0.21250 | −0.2125 |
| 3 | AS->ESC | 0.28055 | 1.00563 | 0.99981 | 1.00000 | 1 |
| 4 | ES->P | 0.62255 | 0.63175 | 0.62964 | 0.62971 | 1.0625 |
| 5 | I->P | 0.43555 | 0.63359 | 0.63118 | 0.63124 | −0.25 |
| 6 | AS->P | 0.62887 | 0.23292 | 0.25034 | 0.24961 | 0 |
| 7 | ES->S | 0.47745 | 0.46825 | 0.47037 | 0.47035 | 0.903125 |
| 8 | I->S | 0.86445 | 0.66642 | 0.66883 | 0.66877 | −0.2125 |
| 9 | AS->S | 0.87113 | 1.26696 | 1.24938 | 1.24945 | 1 |
| | 4-7 | 0.1451 | 0.1635 | 0.15927 | 0.15936 | 0.159376 |
| | 5-8 | −0.4289 | −0.03283 | −0.03765 | −0.03753 | −0.0375 |
| | 6-9 | −0.24226 | −1.03404 | −0.99904 | −0.99984 | −1 |
| | SSE | 3.454487562179 | 0.000304681831 | 0.000000247206 | 0.000000007560 | |

4.3 Generalization

Next is the third question: is the above model generalizable? It is generally agreed in the ANN research field that, given a set of training examples representing the mappings of a function, an ANN can approximate the target function in sufficient training time under a supervisory learning mode. However the purpose of training a network is not only this, since it is also hoped that the ANN will approximate the behavior patterns when an input is out of the range of the training set. If a trained network satisfies this requirement, it is generalized. A generalized PRN will correctly express the behaviors of the original SDM [Sarle, W. S. Neural Network FAQ Part III, ftp://ftp.sas.com/pub/neural/FAQ3.html, 2000].

Generalization is not always possible, however, since it has to satisfy at least three conditions [Sarle, W. S. Neural Network FAQ Part III, ftp://ftp.sas.com/pub/neural/FAQ3.html, 2000]. First, a mathematical function should exist that supports the training data relating inputs to outputs with a certain degree of accuracy. One cannot expect an ANN to learn a nonexistent function. In the SD field, this means that a model should exist which describes the training time series patterns. If a trained PRN can be explained by a human constructor, this model exists, and hence this condition is satisfied.

Secondly, the mathematical function underlying the ANN should be “smooth”. A function ƒ is called smooth in an interval I if the derivative of ƒ (ƒ′) exists and is continuous in I. In other words, a small change in the inputs should produce a small change in the outputs. This is required by the learning mechanism used in an ANN, since it applies the first derivative over an error function in order to find an optimal structure. (Some ANNs can learn in a discontinuous space as long as the function consists of a finite number of continuous pieces.) Since a time series pattern generated by a SDM is composed by two basic smooth functions (i.e., exponential and sine/cosine functions [Forrester, J. W. Principles of Systems, MIT Press, Cambridge, Mass., 1968]), this condition is again satisfied.

Thirdly, there should be sufficient number of representative training examples. This condition applies not only to an ANN; all quantification methods to be generalized have to satisfy this requirement. This issue has been addressed before; without a sufficient number of representative cases, no method will work well. Another way to generate sufficient training examples, when necessary, is using numerical methods as suggested before.

Except the three conditions described above, one also finds that noise and/or the number of hidden layers can have an effect on generalization. Oja and Wang [Oja, E. and Wang, L. “Robust Fitting by Nonlinear Neural Units,” Neural Networks (9:3), 1996, pp. 435-444] have used ANNs to fit linear and nonlinear functions and shown that their results are better than those obtained using a least-square method when the input examples are injected with Gaussian-distributed noises or with some outlying data. In their experiments, the variance of the Gaussian distribution was 0.3 and 0.5; another experiment used 6 outliers. Other papers that describe research in this area include An, G. “The Effects of Adding Noise during Back-propagation Training on a Generalization Performance,” Neural Computation (8), 1996, pp. 643-647 and Holmstrom, L. and Koistinen, P. “Using Additive Noise in Back-propagation Training,” IEEE Transactions on Neural Networks (3), 1992, pp.24-38. The general conclusion is that injecting artificial noises into the inputs during training is a good way to improve generalization for smooth functions when one has only a small training set.

As to the number of hidden layers, a common opinion is that fewer layers produces a better generalization [McCullagh, P. and Nelder, J. A. Generalized Linear Models 2nd ed., Chapman & Hall, London, 1989]. Scarselli and Tsoi [Scarselli, F. and Tsoi, A. C. “Universal Approximation Using Feed-forward Neural Networks: A Survey of Some Existing Methods, and Some New Results,” Neural Networks (11:1), 1998, pp. 15-37] have surveyed the various types of neural networks that approximate a mathematical function, and found that most of them have only one or at most two layers of hidden units. Since our method requires only one layer of hidden units, it is the fewest for generalization.

4.4. Scalability

The last question asks if the method is scalable for any sufficiently complicated system so that it can be used in practical applications. The size of a FD depends on the numbers of levels, flows, rates, and wires. However, when mapping to a PRN, each type of these components has a different impact. Because of the design, units between a state layer and a hidden layer are fully connected. Thus the numbers of levels (corresponding to state units) and rates (corresponding to hidden units) will have a larger impact on the complexity of a network. According to a brief survey (from 1998 to 2000) in the journal System Dynamics Review (SDR), the models presented there have, on average, 5 levels, 5 constants, and 7 rates. The average number of wires is about 30 percent of the number of fully connected links. The largest model was double the size of the average model. Table 10 lists the details of these models.

To be comparable with the largest model in SDR, one expands the fourth model in the previous experiment and arbitrarily adds more variables to the system, which ends up with 10 levels, 6 constants, and 14 rates (Same as the largest model in SDR). Inside this model, there are 4 pairs of rates (flow into and out of the same level) plus 6 single ones, and 36 pairs of wires (16 for relative weights and 20 for absolute weights). The model is assigned with DT=0.5 to simulate the time series patterns for training examples. It runs for 600 time intervals, which generates 600 tuples of training data.

TABLE 10
The sizes of common models.

| | | | | No. of | | |
|---|---|---|---|---|---|---|
| | | | | links | No. of | |
| | No. | | No. | in fully- | wires in | Connec- |
| | of | No. of | of | connected | original | tion |
| | levels | constants | rates | networks | models | rate |
| Order | 1 | 1 | 1 | 2 | 2 | 100% |
| 2^{nd} Order | 2 | 1 | 2 | 6 | 3 | 50% |
| Salesmen | 1 | 0 | 1 | 1 | 1 | 100% |
| Business | 2 | 1 | 3 | 9 | 9 | 100% |
| Avg. in SDR | 5 | 6 | 8 | 88 | 26 | 29% |
| Max. in SDR | 10 | 6 | 14 | 224 | 30 | 13% |

According to the construction process, one first creates an initial structure of the PRN that consists only of the mappings of levels and rates defined in the STELLA. Then the following experiments are performed. The first one, experiment A, is to let units between the state and hidden layers be fully connected, which in total has 160 pairs and 224 links. The network structure and learning effectiveness is shown in the first row of Table 11, where the training process stops at around 1,000,000 epochs. It can be seen that the learning result is not as good as before, with an error of around 0.0038 in SSE; it might converge at a sub-optimal solution. When looking into its network structure, one finds that the degree of similarity with the structure of the original FD is only 43%. Irrespective of whether or not the newly learned model can be interpreted, this experiment does not successfully show the scalability of the method. So, one continues on the next experiment.

In experiment B, one only establishes the links between the state layer and the hidden layer when necessary; i.e., those links that exist in the original model. So there are only 52 adjustable links (corresponding to the 36 pairs of wires) in total. The network structure and learning effectiveness are shown in the second row of Table 11, in which the result is again perfect. The training process stops at 200,000 epochs with an error around 0.0000047 in SSE. In addition, the structure of the two models is identical. However, this experiment does not show either the scalability of the method. So, a third experiment is conducted.

In experiment C, the state layer and the hidden layer are half connected. In addition to the necessary links, more links that were shown to be significant in Experiment A are added, producing a total of 112 adjustable links and 80 pairs of wires. The network structure and learning effectiveness is listed in the third row of Table 11, in which it shows again a perfect result. The training process ends at 500,000 epochs with an error of around 0.0000012 in SSE. In addition, the structure of the two models is identical, and the relationships that do not exist in the original model all receiving a near-zero weight and are removed. So, the third experiment has partially shown the usefulness of the method.

TABLE 11
Experimental results for scalability.

| | Network structure | | | Learning effectiveness | | | |
|---|---|---|---|---|---|---|---|
| | No. of | | | | | No. of | |
| | pairs | | Connec- | | | pairs of | |
| | of | No. of | tion | Epochs | | same | Similar |
| | wires | links | rate* | (x1, 000) | SSE | wires | rate** |
| A | 160 | 224 | 100% | 1,000 | 0.003878784598783 | 69 | 43.12% |
| B | 36 | 52 | 22.5% | 200 | 0.000004738795269 | 36 | 100% |
| C | 80 | 112 | 50% | 500 | 0.000001206433353 | 80 | 100% |
| D | 160 | 224 | 100% | 60,000 | 0.000002345938822 | 160 | 100% |
| E*** | 160 | 224 | 100% | 40,000 | 0.000001125453563 | 160 | 100% |

*Connection rate = no. of relations in networks/no. of relations in fully connected network
**Similar rate = no. of relations in original model/no. of relations in networks
***The ANN is the same as that in experiment D, but is trained stepwise.

Since the latter two experiments all demonstrate effective learning, it is interesting to determine why the first experiment cannot achieve the same result. A fourth experiment is therefore performed that redoes experiment A, but lets the algorithm to continue running until the network converges by itself. The network structure and learning effectiveness is given in the fourth row of Table 11. Surprisingly, a perfect result is again returned although a very long training time is required. The training process ends at 60,000,000 epochs with an error of around 0.0000023 in SSE.

After four experiments, one can confidently conclude that the method according to this invention is scalable and useful in practical applications. Although experiment D uses a brute-force approach to construct the model, it is not suggested that this is a good way to construct the model since it takes too long and does not always guarantee success. The more information that a constructor has about unnecessary links, the larger the chance that the learning process will avoid a local trap and successfully find a correct model structure. Comparing experiments C and D, one can see the big difference in performance when half of the links are removed, since the latter takes 120 times longer to converge to a correct solution.

In order to justify the argument, experiment E is conducted in which one takes a break at each 2,000,000 training epochs and manually deletes those links that have a weight near zero. (This simulates the action of a human constructor with different degree of knowledge.) The process is repeated 20 times and the result of each step is shown in Table 12. The column of “deleted links” also shows a clustering effect in that the links related to a level are learned together, and their sequence is L3_{—}2, I_{—}2, I, ES_{—}2, L1_{—}2, ES, L1, L2_{—}2, L2, and L3.

The experiment also has another purpose. As is shown in the last row of Table 12, the final model created at step 20 has an error that is even smaller than that of experiment D. Comparing the two experiments, the stepwise learning approach saves one-third of the effort involved in converging to a correct solution.

When a model is initially prepared with the inclusion of some predefined model pieces, links inside the pieces are certain. This will greatly reduce the complexity in training the model and make the learning process converge faster.

5.More Experiments in Policy Design

Since the above empirical study shows that neural learning is helpful in identifying the structure of a SDM, it is interesting to know whether the same technique can be applied to policy design. As introduced before, the purpose of policy design is to find a new structure (including parameters) of a given system so that it will behave according to the intention of the model constructor. To investigate whether this idea is correct or not, two types of policy design problems are selected; i.e., the goal of achieving a growing or stable trajectory for a given model. The following experiments are conducted, and two models— “market growth model” and “customer, producer, and employment model”— are tested. They are described in Forrester, J. W. “Market Growth as Influenced by Capital Investment”, Industrial Management Review, 9(2), 1968, pp. 83-105 and Forrester, J. W. Industrial Dynamics, MIT Press, Cambridge, Mass., 1961, respectively.

TABLE 12
The result of stepwise learning.

| | | | Con- | | |
|---|---|---|---|---|---|
| | | No. | nec- | | |
| | No. of | of | tion | | |
| | relations | links | rate* | Deleted links | SSE |
| Step 1 | 160 | 224 | 100% | | 0.003408792894334 |
| Step 2 | 108 | 152 | 67.5% | Constants × | 0.098038695752621 |
| | | | | 52 | |
| Step 3 | 106 | 148 | 66.3% | L3_2 × 2 | 0.003824835876003 |
| Step 4 | 99 | 135 | 61.9% | L3_2 × 6, | 0.004586316179484 |
| | | | | ES × 1 | |
| Step 5 | 97 | 132 | 60.6% | I_2 × 1, | 0.002819428686053 |
| | | | | L1_2 × 1 | |
| Step 6 | 92 | 122 | 57.5% | I_2 × 5 | 0.001274655340239 |
| Step 7 | 91 | 120 | 56.9% | I_2 × 1 | 0.000833343947306 |
| Step 8 | 89 | 116 | 55.6% | I × 2 | 0.000392793823266 |
| Step 9 | 83 | 105 | 51.9% | I × 4, | 0.000226931297220 |
| | | | | L3 × 1, | |
| | | | | ES_2 × 1 | |
| Step 10 | 75 | 96 | 46.9% | L3 × 1, | 0.000215196065255 |
| | | | | ES_2 × 6, | |
| | | | | L1_2 × 1 | |
| Step 11 | 69 | 90 | 43.1% | L1_2 × 5, | 0.000095272829640 |
| | | | | L2_2 × 1 | |
| Step 12 | 66 | 87 | 41.2% | ES × 1, | 0.000039348574322 |
| | | | | L1 × 1, | |
| | | | | L2 × 1 | |
| Step 13 | 61 | 82 | 38.1% | ES × 5 | 0.000014358493302 |
| Step 14 | 60 | 81 | 37.5% | L1 × 1 | 0.000007233048974 |
| Step 15 | 55 | 76 | 34.4% | L1 × 5 | 0.000004294893987 |
| Step 16 | 54 | 75 | 33.8% | L2_2 × 1 | 0.000003223948755 |
| Step 17 | 48 | 69 | 30% | L2_2 × 6 | 0.000002943948482 |
| Step 18 | 47 | 68 | 29.4% | L2 × 1 | 0.000002729292999 |
| Step 19 | 41 | 62 | 25.6% | L2 × 6 | 0.000002529837491 |
| Step 20 | 36 | 52 | 22.5% | L3 × 5 | 0.000001206433353 |

*connection rate = no. of relations in networks/no. of relations in fully connected network

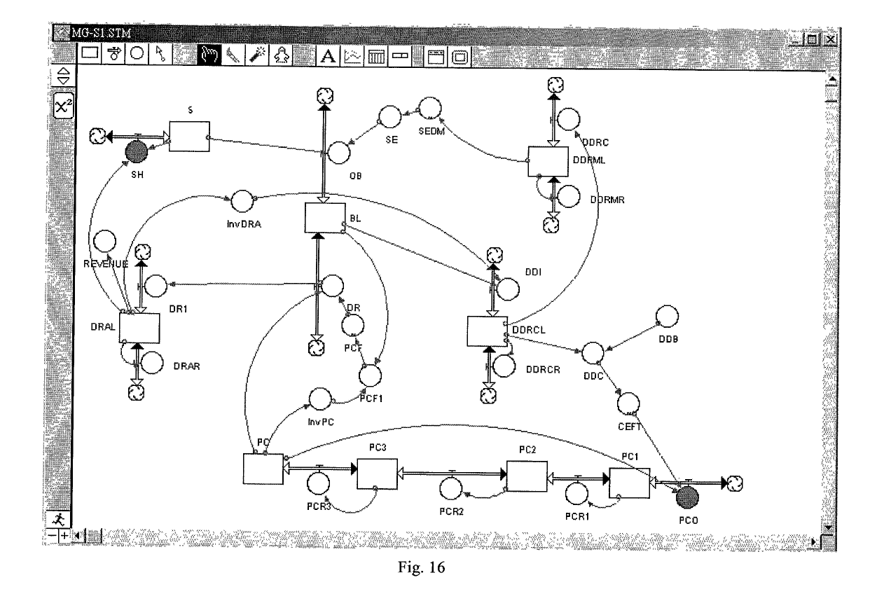

The market growth model arose from the case study of a high-technology company. The company starts by building and selling a unique product with a high-expected market potential. However, after a rapid sales growth in the first three years, the growth rate stops and even reverses. The company therefore needs a new policy to maintain the growing trend. The simplified model of this problem is shown in FIG. 16.

TABLE 13
Policy comparison in the market growth model.

| Rate | Forrester | This experiment |
|---|---|---|
| SH (Salesmen Hiring) | 0.0003 × DRAL − 0.05 × S | −0.05 × S + 0.0003 × DRA + (0.00012 × PC − |
| | | 0.00009 × BL + . . . ) |
| PCO (Production Capacity | PC × CEFT | 0.03518 × PC + 0.02955 × BL − 0.01824 × DRA − |
| Ordering) | | 0.015051 × PC1 + (− 0.00461 × PC2 . . . ) |

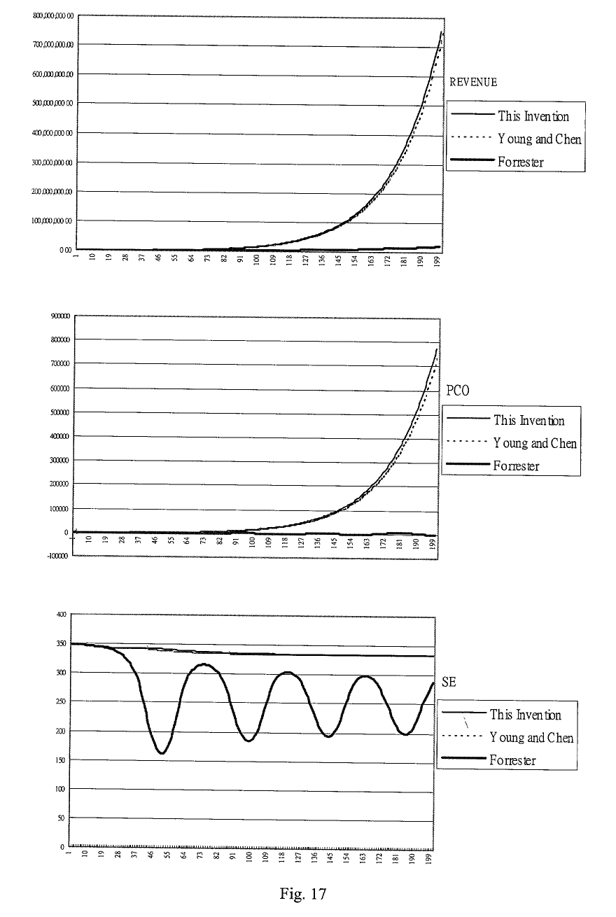

Since there is no given objective trajectory for the growth pattern, the optimal trajectory published in Young, S. H. and Chen, C. P., “A Heuristic Mathematical Method for Improving the Behavior of Forrester's Market Growth Model,” in Proceeding of 16^{th} International Conference of the System Dynamics Society, 1998, is used as the training examples in this experiment. The policy generated by this invention using the learning method of the PRN is compared with Forrester's one (as shown in Table 13). The two SH functions (salesmen hiring) are almost same, but the PCO functions (production capacity ordering) are very different. To compare their performance, this system is simulated and the result trajectories for three variables (production capacity ordering, revenue, and sales effectiveness) are shown in FIG. 17. As one can see, the trajectories for variables PCO and revenue produced by the new policy are the best (i.e., better growing trend) among the three (i.e., Forrester, Young and Chen, and this invention).

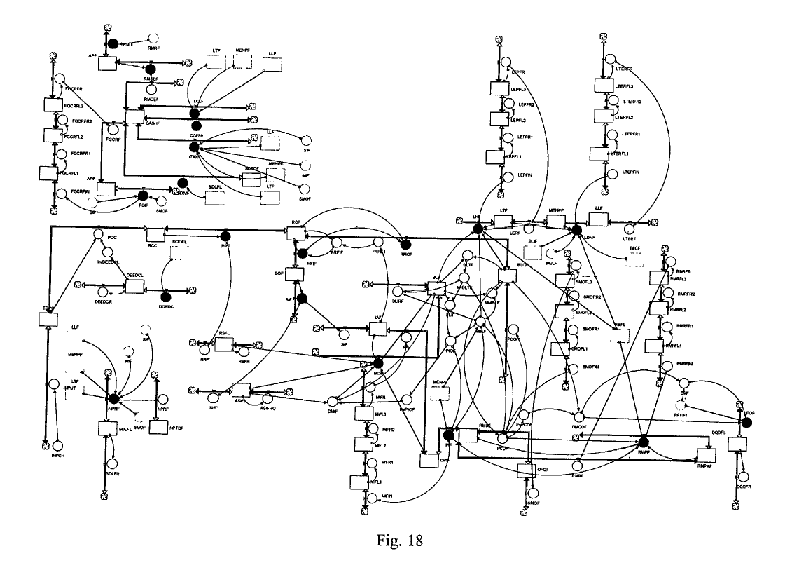

The customer, producer and employment model arose from the case study of a company in the electronic components industry, which supplies components to other manufacturers. The company has been experiencing fluctuations in production and employment. Its incoming orders fluctuate over a very wide range on a week-by-week basis. The fluctuations have been assumed to come exclusively from the varying demand rate by the company's customers. The previous study was aimed at determining if the symptoms arose from the internal structure and policies of the system. The simplified model for this problem is shown in FIG. 18.

The policy design in this problem is to find a way that will reduce the fluctuations in production and employment. Therefore, the ideal trajectories to be learned are flat lines, which include five variables: backlog for customer at factory (BLCF), cash balance at factory (CASHF), delay quoted delivery at factory (DQDF), inventory actual at factory (IAF), and men producing at factory (MENPF). The policy generated in this experiment is compared with that of Forrester in Table 14. In this case, most of rate equations suggested by the new policy are different from those of Forrester.

Table 15 compares the performance of the two policies. Their relative effectiveness is measured by an index, which is described as follows:

$$Index ( V ) = \frac{\sqrt{{\sum }_{t} {( \frac{{V}_{t} - \overline{V}}{\overline{V}} )}^{2}}}{\sqrt{{\sum }_{t} {( \frac{{INP}_{t} - \overline{INP}}{\overline{INP}} )}^{2}}}$$

where,

Index is a measurement for stability,

V is a variable,

Vₜ is the value of variable V at time t,

TABLE 14
Policy comparison in the customer, producer, and employment model.

| Rate | Meaning | Forrester | This experiment |
|---|---|---|---|
| DDEDC | Delay Desired in | 37.05 − 0.375 × DQDFL | 63.99424 − 1.82232 × DQDFL |
| | Engineering Department | | |
| | of Customer | | |
| DFOF | Delay to Fill Orders at | 3 + 4 × FRFIF1 + 0.2 × DMCOF + | 4.69829 + 0.01474 × FRFIF1( + |
| | Factory | 0.8 × DVZF | 0.00031 × DMCOF) − 0.00266 × |
| | | | DVF |
| FGIF | Finished Goods Invoice | 100 × SOF + 50 × SMOFL3 | 100 × SOF + 50 × SMOFL3 + |
| | rate at Factory | | 1.54986 × FGCRFL3 − 1.05554 × |
| | | | FGCRFL1 − 1 × EDPC + 2.24756 × |
| | | | CASHF + . . . |
| CCEFR+ | Constant Cash | 15000 + 25 × SOF + 20 × SMOFL3 | −140650 + 25 × SOF + 20 × |
| ITAXF+ | Expenditure rate at | +7.5 × MIFL3 + 40 × LLF + 40 × | SMOFL3 + 7.5 × MIFL3 + 40 × LLF+ |
| LCEF | Factory + Income TAX at | LTF + 40 × MENPF | 40 × LTF + 40 × MENPF + . . . |
| | Factory + Labor Cash | | |
| | Expenditure at Factory | | |
| LDNF | Labor Dismissal Notice | −(0.002 × RSFL + 0.001875 × | −0.00236 × RSFL − 0.00095 × |
| | rate at Factory | BLIF + 0.001875 × BLCF + 0.1 × | BLIF − 0.00167 × BLCF + 0.1 × LTF + |
| | | MBLF − 0.1 × LTF − 0.2 × MENPF) | 0.2 × MENPF − 0.1 × MBLF + . . . |
| LHF | Labor Hiring rate at | 0.002 × RSFL + 0.001875 × BLIF + | 0.00199 × RSFL + 0.00187 × |
| | Factory | 0.001875 × BLCF + 0.1 × MBLF − | BLIF + 0.00187 × BLCF − 0.1 × LTF − |
| | | 0.1 × LTF − 0.2 × MENPF | 0.2 × MENPF + 0.1 × MBLF + . . . |
| MOIF | Manufacturing Order for | ASIFL + (2/45) × RSFL − (1/6) × | ASIFL + 0.03029 × RSFL − 0.17115 |
| | Inventory at the Factory | IAF + (1/12) × DMIF − (1/6) × BLIF − | × IAF − 0.17126 × BLIF − 0.17120 |
| | | (1/6) × OPIF | × OPIF + 0.03862 × EDPC + |
| | | | 0.03125 × DMIF + . . . |
| NPRF | Net Profit Rate at Factory | 25 × SOF + 20 × SMOFL3 − 40 × | 25 × SOF + 20 × SMOFL3 − 40 × |
| | | LLF − 40 × LTF − 40 × MENPF + 7.5 × | LLF − 40 × LTF − 40 × MENPF + |
| | | MIFL3 − 15000 | 7.5 × MIFL3 + 7700 + 0.55631 × |
| | | | CASHF + . . . |
| PIF | Production rate starts for | PIOF + MENPF × (8/3) − MBLF × | PIOF + MENPF × 2.66667 − |
| | Inventory at Factory | (8/3) | MBLF × 2.66667 + . . . |
| RFIF | Requisition rate Filled | 0.8 × RCF − 0.8 × FRFIF | 0.8 × RCF − 0.8 × FRFIF + . . . |
| | from Inventory at Factory | | |
| RMCEF | Raw Material Cash | APF/3 | APF × 0.22549 + 0.33020 × |
| | Expenditure at Factory | | CASHF + 0.13892 × FGCRFL3 |
| RMIF | Raw Material Invoice | RMRF × 20 | RMRFL3 × 20 + 0.2 × CASHF − |
| | rate at Factory | | 0.10282 × FGCRFL1 |
| RMOF | Requisition rate | 0.2 × RCF + 0.8 × FRFIF | 0.2 × RCF + 0.8 × FRFIF |
| | Manufactured to Order at | | |
| | Factory | | |
| RMPF | Raw Material Purchases | PCOF + PIOF + (8/3)(MENPF − | PCOF + PIOF + MENPF × |
| | at Factory | MBLF) + 0.075 × RSFL − 0.125 × RM | 2.66678 − MBLF × 2.66667 + |
| | | SF − 0.125 × RMPAF | 0.05597 × RSFL − 0.12503 × |
| | | | RMSF − 0.12499 × RMPAF + . . . |
| RRF | Requisition rate Received | RCC/3 | RCC × 0.33333 |
| | at Factory | | |
| SDIVF | Stockholder Dividends at | SDLFL/52 | SDLFL × − 0.02192 + 0.08305 × |
| | Factory | | CASHF + . . . |
| SIF | Shipments from | SOF | SOF |
| | Inventory at Factory | | |

\overline{V} is the mean value of variable V,

INPₜ is the value of the input variable at time t, and

\overline{INP} is the mean value of the input variable.

TABLE 15
Effectiveness comparison in the customer,
producer, and employment model.

| | Index | Index | Index | Index | Index |
|---|---|---|---|---|---|
| | (BLCF) | (CASHF) | (DQDF) | (IAF) | (MENPF) |
| Original model | 9.531842615 | 10.95658526 | 3.257822065 | 3.019496718 | 2.291600865 |
| Forrester's policy | 1.815229305 | 3.043170553 | 0.768371778 | 2.125290659 | 0.742282703 |
| Ideal policy | 0 | 0 | 0 | 0 | 0 |
| This experiment | 5.895337643 | 0.178236311 | 0.000576268 | 2.670666767 | 0.806685149 |

The physical meaning of this index is to compare the fluctuation of a particular output variable with that of the input variable. If the index is less than one, then a policy has effectively reduced the fluctuation. As one can see, Forrester's policy outperforms in variable BLCF, while the newly generated policy is superior in variables DQDF and CASHF. The two policies were tied in the other two variables.

Through the above experiments, it is seen that the neural learning capability that results from the PRN representation can also be extended to applications in policy design. In the two experiments described above, the effectiveness of the proposed method is comparable or even outperforms previous approaches. Irrespective of whether the desired pattern is a growth trajectory or a stable one, the proposed method handles it well, resulting not only in better parameter values but also in possible changes in structure. Thus it suggests a policy from an overall perspective. This touches an area that none of the current approaches has been able to achieve.

6. Conclusion

In the last section, a rigid empirical analysis is performed from four different aspects in order to investigate the application of the presented method in pragmatic situations, and the method has demonstrated good performance in each of them. Thus there is no doubt about the validness and effectiveness of the presented method since the equivalence of the two types of representation for a SDM has also been shown both theoretically and experimentally. With the additional PRN for a SDM, some traditionally difficult problems can now be made easier in the new representation, and some example applications are demonstrated. It can be seen that the automatic learning capability of an ANN can indeed assist in the construction and manipulation of a SDM.

The approach proposed in the present invention is quite different from traditional ones, in which a deduction process is performed based on a person's observations and intelligence during the construction of a model. The difficulty of these approaches is that the target to be modeled is a dynamically complicated system and there are no systematic guidelines or observable objects for assistance during the construction process. Thus the constructor's insight and experiences determines the quality of the created model. The new approach, in contrast, is a process of induction based on evidence. The method relies on a well-established artificial intelligence algorithm to systematically search a problem space and check out every possibility of cause-effect relationships in order to identify the most appropriate structure for a model. Furthermore, the automatic method complements traditional approaches. It does not replace the traditional role of a human expert in model construction but assist him/her. A composite approach that integrates the capability of neural network learning with a traditional process is proposed, which allows the domain expert to input his/her insight as well as experiences in the preparation of the model's initial skeleton, and then evaluate the system structure generated. It is expected that this approach will reduce the entry barrier of promoting the applications of SD science to various business or social areas, without being limited by the availability of human experts.

What is claimed is:

1. A mapping algorithm for transforming models between the two types, from a Forrester flow diagram (FD) to a partial recurrent neural network (PRN), and vice versa, the mapping algorithm comprising:
relating levels (and constants) to the input, output, and state units;
relating rates (and auxiliaries) to hidden units;
relating wires to links from the said state units to the said hidden units;
relating flows to links from the said hidden units to the said output units;
assigning the value of DT as the weights of links from the said hidden units to the said output unit; and
assigning coefficients in rate equations as the weights of links from the said state units to the said hidden units.

2. A semiautomatic learning method for system dynamics model (SDM) construction and manipulation, the method comprising:
creating an initial structure of the said PRN;
creating a training set with special arrangements; and
training the said PRN with the said training set.

3. A policy design method for SDMs, the method comprising:
representing a target SDM as said PRN;
according to the intention of a model constructor, training said PRN with a special arrangement data set like those in said claim 2; and
identifying the changes in structure and parameters values between the two said PRNs, which leads to an overall policy for model manipulation.

4. The mapping algorithm, as recited in claim 1, further comprising:
implementing a level equation by a weighted sum of output values from said hidden and said state units connected to said output unit via links;
implementing a rate equation by a weighted sum of output values from said state units connected to said hidden unit via links;
relating initialization equations to the corresponding links from said input units to said output units; and
relating constant equations to said corresponding links from said state units to said output units, and also from said output units to said state units.

5. The method of claim 2, wherein said step of creating a training set with special arrangement including:
creating a set of two-part training tuples, with the input part representing values for said input units and the output part representing values for said output units;
assigning both of the two parts of said first training tuple with the initial values of levels and constants; assigning the output part of the rest of said training tuples with the historical time series of data from said levels and constants, with one tuple for each time step;
resetting the input part of the rest of said training tuples to zero; and
ordering said training tuples in time sequence.

6. The mapping algorithm, as recited in claim 1, further comprising:
interpreting the structure of said PRN learned by said method of claim 2 and transforming it back to said FD using the relationships listed in claim 1; and
dropping those links from said state units to said output units with near-zero weights.

7. The method of claim 3, wherein said step of training said PRN with a special arrangement data set including:
using a flat line as the training data set if the problem is to search for a policy that will generate a stable trajectory for a given model; and
generating the training data set either by an optimal algorithm or manually by a domain expert if the problem is to search for a policy that will generate a growing trajectory for a given model.
